(19) United States
(12) Patent Application Publication
(10) Pub. No.: US 2002/0024598 A1
(43) Pub. Date: Feb. 28, 2002

(54) Detecting system for container's location

(76) Inventors: Satoshi Kunimitsu, Koganei-shi (JP); Hajime Asama, Wako-shi (JP)

Correspondence Address: BIRCH STEWART KOLASCH & BIRCH, PO BOX 747, FALLS CHURCH, VA, 22040-0747, US

(21) Appl. No.: 09/911,728

(22) Filed: Jul. 25, 2001

(30) Foreign Application Priority Data
Jul. 25, 2000 (JP) 2000-223683
Mar. 28, 2001 (JP) 2001-91911

(51) Int. Cl. H04N 7/18

(52) U.S. Cl. 348/159

(57) ABSTRACT

In order to be able to detect a three-dimensional relative position on a container load cargo with respect to a hoisting accessory, a detecting system for a container's location is provided with a plurality of CCD cameras disposed vertically downward on the hoisting accessory, which is mounted on a crane for conveying containers, and photographing a plurality of corner fittings mounted on the upper surface of the container load cargo, respectively; a distance finder for determining a distance between the hoisting accessory and the container load cargo; an image processor for image-processing video signals from the CCD cameras to detect two-dimensional coordinates of the corner fittings on the upper surface of the container load cargo; and an arithmetic and control unit for performing an arithmetical operation of the three-dimensional relative position on the surface of the container load cargo with respect to the hoisting accessory on the basis of the two-dimensional coordinates of the plurality of corner fittings on the upper surface of the container load cargo, which were detected by the image processor, as well as distance information indicating a distance between the hoisting accessory and the container load cargo, which was determined by the distance finder.

### BACKGROUND OF THE INVENTION

1. Field of the Invention

The present invention relates to a detecting system for a location of a container (hereinafter referred optionally to as “detecting system for a container's location”, and more particularly to a detecting system for a container's location by which correct positioning of a hoisting accessory of a crane for conveying containers such as a container crane, and a transfer crane as well as of a container to be loaded and unloaded (hereinafter referred optionally to as “container load cargo”) is made, whereby an engaging device mounted on the hoisting accessory is positioned correctly at a position for suspending the container in handling work for engaging the hoisting accessory with the container to be loaded and unloaded.

2. Description of the Related Art

Heretofore, for example, a conventional detecting system for a location of a container as shown in FIGS. 1 and 2 has been proposed as a system for detecting a container's location by which correct positioning of a hoisting accessory of a crane for conveying containers such as a container crane, and a transfer crane as well as of a container load cargo is made, whereby an engaging device mounted on the hoisting accessory is positioned correctly at a position for suspending the container or the like in handling work for engaging the hoisting accessory with the container load cargo.

FIG. 1 is a constitutional block diagram showing a conventional detecting system for a container's location, and FIG. 2 is a perspective view showing constitutions of a variety of instruments in the conventional detecting system for a container's location.

The conventional detecting system for a container's location is provided with CCD cameras 200a, 200b, 200c, and 200d disposed vertically downwards on four corners of the under surface 100a of a hoisting accessory 100 mounted in a crane for conveying containers such as a container crane, and a transfer crane as well as for photographing corner fittings 104a, 104b, 104c, and 104d disposed on four corners of the upper surface 102a of a container 102 to be laded and unloaded (container load cargo) deposited on a container ship or a container terminal, respectively.

The detecting system for a container's location is further provided with image processors 202a, 202b, 202c, and 202d for image-processing video signals from the CCD cameras 200a, 200b, 200c, and 200d to detect locations of the corner fittings 104a, 104b, 104c, and 104d on the container 102, respectively, and an arithmetic and logic unit 204 to carry out arithmetical operation for determining a three-dimensional position of the upper surface 102a of the container 102 with respect to the hoisting accessory 100 on the basis of positions of the corner fittings 104 through 104d mounted on the container 102, which were detected by the image processors 202a through 202d, respectively.

Such conventional detecting system for a container's location can detect a three-dimensional relative position defined by the hoisting accessory 100 of a container crane or a transfer crane and the container load cargo 102. Accordingly, it is effective for positioning correctly the hoisting accessory 100.

In the above-described conventional detecting system for a container's location, for example, a manner for template matching processing is used as an image processing method for image-processing video signals from the CCD cameras 200a through 200d by means of the image processors 202a through 202d to detect locations of the corner fittings 104a through 104d on a side of the upper surface 102a of the container 102.

However, there has been a problem of increase in detection error, or a possibility of detection incapability or erroneous detection in the case when a size of an object to be detected changes on image in a manner of template matching processing.

Namely, since the CCD cameras 200a through 200d are disposed on the hoisting accessory 100 of a crane for conveying containers such as a container crane, and a transfer crane, a distance for photographing, which is defined between any of the CCD cameras 200a through 200d and the container 102, changes with a lowering distance of the hoisting accessory 100, so that each size of the corner fittings 104a through 104d on video signals (image data) photographed by the CCD cameras 200a through 200d mounted on the hoisting accessory 100 changes. As a result, there has been a fear of increase in detection error, or a possibility of detection incapability, or erroneous detection in template matching processing.

In order to eliminate the above-described problems, it may be considered that a number of template images (reference patterns) as to a variety of sizes of the corner fittings 104a through 104d have been previously prepared prior to template-matching of image data photographed by the CCD cameras 200a through 200d, and plural times of template matching processing are conducted upon these reference patterns.

In this case, a process for selecting the optimum template image is equivalent to that of detecting locations of the corner fittings 104a through 104d.

However, there has arose such a new problem that when the above-described plural times of template matching processing are carried out, processing periods of time are accumulated for respective template matching processing, whereby vast amounts of processing time are required.

In addition, there has been also such a problem that a preliminary operation for a long period is required for collecting template images (reference patterns) of the coroner fittings 104a through 104d each having a variety of sizes.

### Object and Summary of The Invention

The present invention has been made in view of the above-described various problems involved in the prior art, and an object of the invention is to provide a detecting system for a location of a container by which a three-dimensional relative position on the upper surface of the container to be loaded and unloaded (container load cargo) can be correctly detected with respect to a hoisting accessory, even if a photographing distance defined between each of CCD cameras mounted on the hoisting accessory and the container load cargo changes with a lowering distance of the hoisting accessory so that a size in each of corner fittings on video signals (image data) photographed by the CCD cameras changes.

Furthermore, another object of the present invention is to provide a detecting system for a container's location by which correct template matching processing can be made without requiring a preliminary collection of a number of template images (reference patterns) as to corner fittings each having a variety of sizes, even if a photographing distance defined between each of CCD cameras mounted on a hoisting accessory and a container load cargo changes with a lowering distance of the hoisting accessory so that a size in each of the corner fittings on video signals (image data) photographed by the CCD cameras changes.

In order to achieve the above-described objects, a detecting system for a container's location according to the present invention comprises a plurality of CCD cameras disposed vertically downward on a hoisting accessory, which is mounted on a crane for conveying containers, and photographing a plurality of corner fittings mounted on the upper surface of a container to be loaded and unloaded (container load cargo), respectively; a distance finder for determining a distance between the hoisting accessory and the container load cargo; an image processor for image-processing video signals from the CCD cameras to detect two-dimensional coordinates of the corner fittings on the upper surface of the container load cargo; and an arithmetic and control unit for performing an arithmetical operation of a three-dimensional relative position on the surface of the container load cargo with respect to the hoisting accessory on the basis of the two-dimensional coordinates of the plurality of corner fittings on the upper surface of the container load cargo, which were detected by the image processor, as well as distance information indicating a distance between the hoisting accessory and the container load cargo, which was determined by the distance finder; whereby a three-dimensional relative position defined between the hoisting accessory and the container load cargo is detected.

Therefore, according to the present invention, an arithmetical operation is performed as to a three-dimensional relative position on the surface of the container load cargo with respect to the hoisting accessory on the basis of the two-dimensional coordinates of the plurality of corner fittings on the upper surface of the container load cargo, which were detected by the image processor, as well as distance information indicating a distance between the hoisting accessory and the container load cargo, which was determined by the distance finder, whereby a three-dimensional relative position defined between the hoisting accessory and the container load cargo is detected. Thus, even if a photographing distance defined between the CCD cameras mounted on the hoisting accessory and the container load cargo changes with lowering of the hoisting load cargo so that sizes of the corner fittings on video signals (image data) photographed by the CCD cameras vary, it becomes possible to correctly detect a three-dimensional relative position on the upper surface of the container load cargo with reference to the hoisting accessory.

Moreover, a detecting system for a container's location according to the present invention comprises a plurality of CCD cameras disposed vertically downward on a hoisting accessory, which is mounted on a crane for conveying containers, and photographing a plurality of corner fittings mounted on the upper surface of a container load cargo, respectively; a plurality of illuminating light sources disposed vertically downward on the hoisting accessory and for illuminating the plurality of corner fittings mounted on the upper surface of the container load cargo, respectively; a distance finder for determining a distance between the hoisting accessory and the container load cargo; an image processor for image-processing video signals from the CCD cameras to detect two-dimensional coordinates of the corner fittings on the upper surface of the container load cargo; and an arithmetic and control unit for performing an arithmetical operation of a three-dimensional relative position on the surface of the container load cargo with respect to the hoisting accessory on the basis of the two-dimensional coordinates of the plurality of corner fittings on the upper surface of the container load cargo, which were detected by the image processor, as well as distance information indicating a distance between the hoisting accessory and the container load cargo, which was determined by the distance finder; whereby a three-dimensional relative position defined between the hoisting accessory and the container load cargo is detected.

Therefore, according to the present invention, an arithmetical operation is performed as to a three-dimensional relative position on the surface of the container load cargo with respect to the hoisting accessory on the basis of the two-dimensional coordinates of the plurality of corner fittings on the upper surface of the container load cargo, which were detected by the image processor, as well as distance information indicating a distance between the hoisting accessory and the container load cargo, which was determined by the distance finder, whereby a three-dimensional relative position defined between the hoisting accessory and the container load cargo is detected. Thus, even if a photographing distance defined between the CCD cameras mounted on the hoisting accessory and the container load cargo changes with lowering of the hoisting load cargo so that sizes of the corner fittings on video signals (image data) photographed by the CCD cameras vary, it becomes possible to correctly detect a three-dimensional relative position on the upper surface of the container load cargo with reference to the hoisting accessory.

In addition, according to the above-described invention, since the plurality of corner fittings mounted on the upper surface of the container load cargo are illuminated by the plurality of illuminating light sources, respectively, even if the container load cargo is located in a dark place, it becomes possible to photograph the plurality of corner fittings mounted on the upper surface of the container load cargo by means of the plurality of CCD cameras, respectively.

In these circumstances, the above-described invention may comprise further a controller for adjusting outputs of the above-described plurality of illuminating light sources based on the distance information indicating a distance between the hoisting accessory and the container load cargo determined by the above-described distance finder.

According to such arrangement as described above, outputs of the illuminating light sources can be efficiently controlled by the controller.

Furthermore, the above-described image processor may be the one for detecting the above-described corner fittings on the upper surface of the container load cargo in accordance with template matching processing, which image-processes video signals from the above-described CCD cameras to detect a region wherein the corner fittings are located, and prepares template images on the basis of the results detected.

According to such arrangement as described above, even if a photographing distance between the CCD cameras mounted on the hoisting accessory and the container load cargo changes with lowering of the hoisting accessory so that sizes of the corner fittings on video signals (image data) photographed by the CCD cameras vary, it becomes possible to implement correct template matching processing without requiring to prepare previously a number of template images (reference patterns) of corner fittings having various sizes.

Further, the above-described image processor may be the one for updating sizes of the above-described template image on the basis of distance information indicating a distance between the above-described hoisting accessory and the above-described container load cargo determined by the above-described distance finder to detect the corner fittings on the upper surface of the container load cargo by the use of the template images thus updated as well as input images represented by the video signals from the above-described CCD cameras in accordance with template matching processing.

Still further, the above-described image processor may be the one for changing sizes of input images represented by the video signals from the above-described CCD cameras on the basis of distance information indicating a distance between the above-described hoisting accessory and the above-described container load cargo determined by the above-described distance finder to detect the corner fittings on the upper surface of the container load cargo by the use of the input images the sizes of which were thus changed as well as the above-described template images in accordance with template matching processing.

Yet further, the above-described plurality of CCD cameras may be the ones each for changing automatically a photographing magnification on the basis of distance information indicating a distance between the above-described hoisting accessory and the above-described container load cargo determined by the above-described distance finder to keep a size of an input image represented by video signals from the CCD cameras always constant.

Moreover, the above-described image processor may be the one for detecting the above-described corner fittings on the upper surface of the above-described container load cargo in accordance with template matching processing, which stores a region wherein the corner fittings each having a size in response to distance information indicating a distance between the hoisting accessory and the container load cargo have been located as a template image.

Besides, the above-described image processor may be the one for detecting the above-described corner fittings on the upper surface of the above-described container load cargo in accordance with template matching processing, which involves a preparation means for preparing template images of corner fittings in the every container load cargos; and the preparation means may be the one for image-processing video signals from the above-described CCD cameras to restrict a region wherein the corner fittings reside in case of implementing the above-described template matching processing, executing template matching processing by the use of template images for detecting hole parts of a plurality of corner fittings, which have been previously prepared in the restricted region to detect hole central positions in the corner fittings, and preparing template images of the corner fittings on the basis of the hole central positions of the corner fittings thus detected.

According to such arrangement as described above, a preparation of template images is not made on the basis of an intersecting point obtained by linearization of two contour lines, but it becomes possible to be sufficient for only restricting a region wherein corner fittings reside on the basis of the intersecting point. Further, according to such arrangement as described above, template matching processing is implemented by the use of template images of hole parts in the pluralities of corner fittings to detect hole central positions in the corner fittings, so that template images can be positively prepared from the region of corner fittings.

In the case when a relative value calculated in accordance with template matching processing is equal to or less than a threshold value, a possibility of erroneous detection can be reduced to the utmost as a result of adding a judgment of incapability of detection. In this case, a countermeasure for incapability of detection may be made by repeating the detection processing or requesting an intervention with an operator.

Furthermore, the above-described image processor may be the one for detecting the above-described corner fittings on the upper surface of the above-described container load cargo in accordance with template matching processing, which involves a preparation means for preparing template images of corner fittings in the every container load cargos; and the above-described preparation means is the one for executing template matching processing by the use of template images for detecting hole parts of a plurality of corner fittings, which have been previously prepared with respect to video signals from the above-described CCD cameras to detect hole central positions in the corner fittings in case of implementing the above-described template matching processing, and preparing template images of the corner fittings on the basis of the hole central positions of the corner fittings thus detected.

According to such arrangement as described above, there is no need for detecting contour lines on the upper surface of a container, so that template matching processing is implemented with respect to either the entire region or a region, which is anticipated to involve corner fittings, by the use of template images of hole parts in the plurality of corner fittings to detect hole central positions of the corner fittings, and the template images of the corner fittings can be prepared on the basis of the data thus detected.

In the case when a relative value calculated in accordance with template matching processing is equal to or less than a threshold value, a possibility of erroneous detection can be reduced to the utmost as a result of adding a judgment of incapability of detection. In this case, a countermeasure for incapability of detection may be made by repeating the detection processing or requesting an intervention with an operator.

Moreover, the above-described image processor is the one for detecting the above-described corner fittings on the upper surface of the above-described container load cargo in accordance with template matching processing, which involves a preparation means for preparing template images of vicinities of holes of corner fittings in the every container load cargos; and the above-described preparation means may be the one for image-processing video signals from the above-described CCD cameras to restrict a region wherein the corner fittings reside in case of implementing the above-described template matching processing, and executing template matching processing by the use of template images for detecting vicinities of holes of a plurality of corner fittings, which have been previously prepared in the restricted region, to prepare template images of the vicinities of the holes of the corner fittings.

According to such arrangement as described above, a preparation of template images is not made on the basis of an intersecting point obtained by linearization of two contour lines, but it becomes possible to be sufficient for only restricting a region wherein corner fittings reside on the basis of the intersecting point. Further, according to such arrangement as described above, template matching processing is implemented by the use of template images of hole parts in the pluralities of corner fittings to detect hole central positions in the corner fittings, so that template images of the vicinities of the holes in the corner fittings can be prepared on the basis of the data detected.

In the case when a relative value calculated in accordance with template matching processing is equal to or less than a threshold value, a possibility of erroneous detection can be reduced to the utmost as a result of adding a judgment of incapability of detection. In this case, a countermeasure for incapability of detection may be made by repeating the detection processing or requesting an intervention with an operator.

Besides, the above-described image processor is the one for detecting the above-described corner fittings on the upper surface of the above-described container load cargo in accordance with template matching processing, which involves a preparation means for preparing template images of vicinities of holes of corner fittings in the every container load cargos; and the above-described preparation means may be the one for executing the template matching processing by the use of template images for detecting vicinities of holes of a plurality of corner fittings, which have been previously prepared with respect to video signals from the above-described CCD cameras to prepare template images of the vicinities of the holes of the corner fittings in case of implementing the above-described template matching processing.

According to such arrangement as described above, there is no need for detecting contour lines on the upper surface of a container, so that template matching processing is implemented with respect to either the entire region or a region, which is anticipated to involve corner fittings by the use of template images of hole parts in the plurality of corner fittings to detect hole central positions of the corner fittings, and the template images of the vicinities of the holes in the corner fittings can be prepared on the basis of the data thus detected.

In the case when a relative value calculated in accordance with template matching processing is equal to or less than a threshold value, a possibility of erroneous detection can be reduced to the utmost as a result of adding a judgment of incapability of detection. In this case, a countermeasure for incapability of detection may be made by repeating the detection processing or requesting an intervention with an operator.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 is a constitutional block diagram showing a conventional detecting system for a container's location;

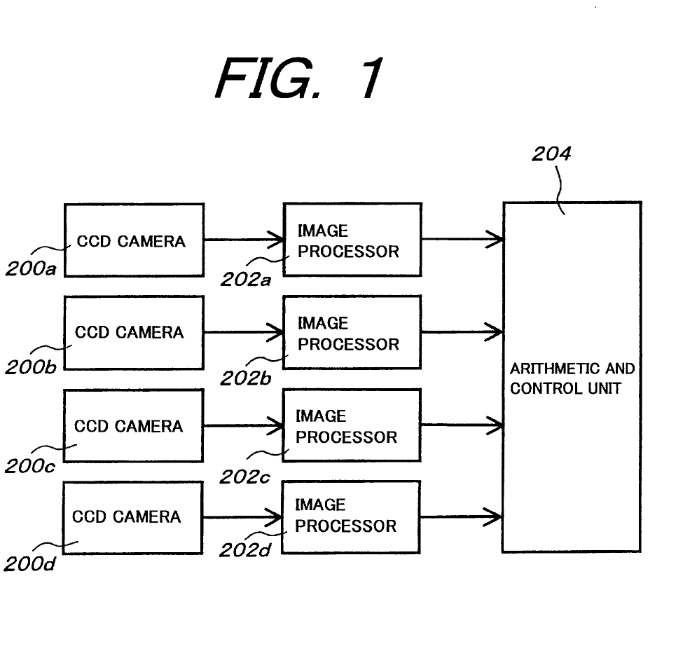

FIG. 2 is a perspective view illustrating constitutions of a variety of instruments in the conventional detecting system for a container' location;

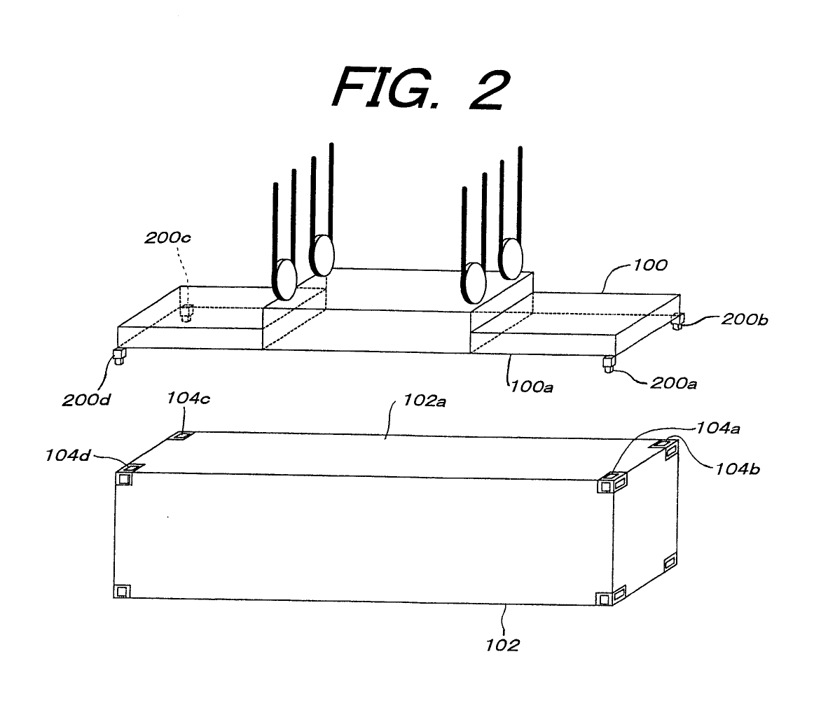

FIG. 3 is a constitutional block diagram showing a detecting system for a container's location according to a first embodiment of the present invention;

FIG. 4 is a perspective view showing the detecting system for a container's location according to the first embodiment of the present invention;

FIG. 5 is an explanatory view illustrating an entire constitution of a container crane provided with the detecting system for a container's location according to the first embodiment of the present invention;

FIG. 6 is a flowchart showing a processing routine executed in the detecting system for a container's location according to the first embodiment of the present invention;

FIGS. 7(a) through 7(d) are explanatory views each illustrating a manner of detection in a corner fitting region in the detecting system for a container's location according to the first embodiment of the present invention;

FIG. 8 is an explanatory block diagram showing a process for scale-transforming a template image to update the data in the detecting system for a container's location according to the first embodiment of the present invention;

FIG. 9 is a constitutional block diagram showing a detecting system for a container's location according to a second embodiment of the present invention;

FIG. 10 is a constitutional block diagram showing a detecting system for a container's location according to a third embodiment of the present invention;

FIG. 11 is a perspective view showing constitutions of a variety of instruments in the detecting system for a container's location according to the third embodiment of the present invention;

FIG. 12 is a flowchart showing a processing routine executed in a detecting system for a container's location according to a fourth embodiment of the present invention;

FIG. 13 is a flowchart showing a processing routine executed in a detecting system for a container's location according to a fifth embodiment of the present invention;

FIG. 14 is an explanatory block diagram showing a process for scale-transforming an input image in the detecting system for a container's location according to the fifth embodiment of the present invention;

FIG. 15 is an explanatory block diagram showing a process for scale-transforming an input image, and updating a reference pattern in the detecting system for a container's location according to the fifth embodiment of the present invention;

FIG. 16 is a flowchart showing a processing routine executed in a detecting system for a container's location according to a sixth embodiment of the present invention;

FIG. 17 is an explanatory block diagram showing a process for scale-transforming a template image to update the data in the detecting system for a container's location according to the sixth embodiment of the present invention;

FIGS. 18(a) through 18(f) are explanatory views each showing a manner for detecting corner fitting regions to prepare a template image in accordance with a first modified example of an image processor;

FIGS. 19(a) through 19(e) are explanatory views each showing a process for preparing three types of feature template (for detecting hole parts) images required for preparing a template image in accordance with the first modified example, a second, third, and fourth modified examples of the image processor;

FIGS. 20(a) through 20(c) are explanatory views each showing a manner for detecting corner fitting regions to prepare a template image in accordance with the second modified example of the image processor;

FIGS. 21(a) through 21(f) are explanatory views each showing a manner for detecting corner fitting regions to prepare a template image in accordance with the third modified example of the image processor; and

FIGS. 22 (a) through 22(c) are explanatory views each showing a manner for detecting corner fitting regions to prepare a template image in accordance with the fourth modified example of the image processor.

### DETAILED DESCRIPTION OF THE PREFERRED EMBODIMENTS

Preferred embodiments of a detecting system for a container's location according to the present invention will be described in detail hereinafter by referring to the accompanying drawings.

In the following description, the same or equivalent components as or to those of respective figures are represented by the same reference characters throughout the respective views wherein detailed descriptions as to these constitutions and explanations of functions therefor will be omitted.

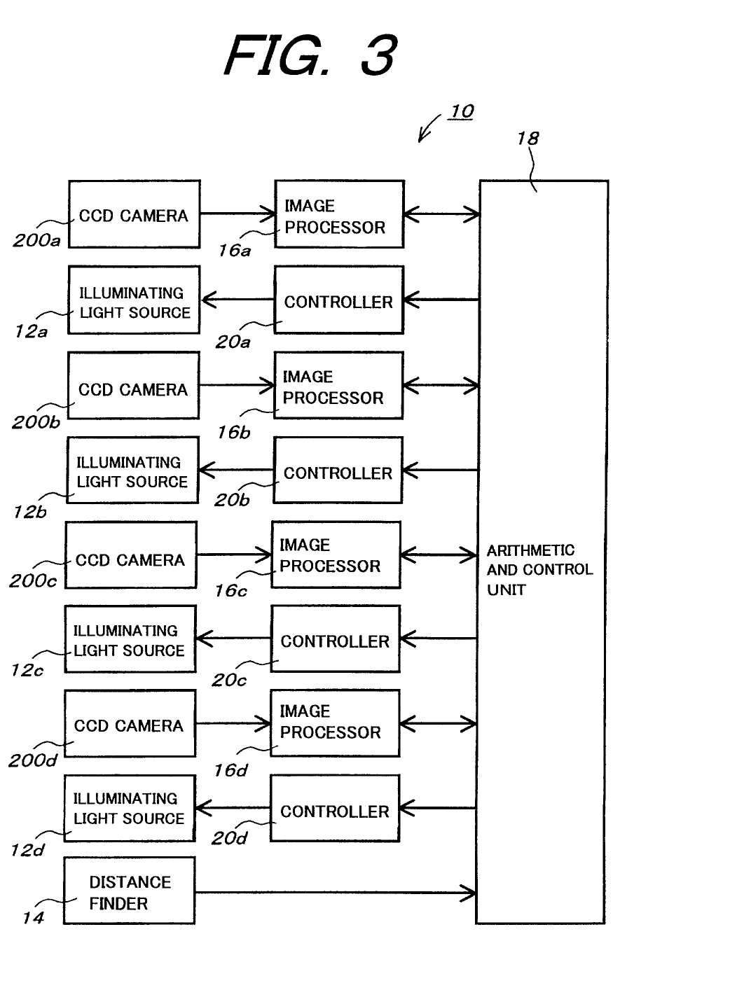

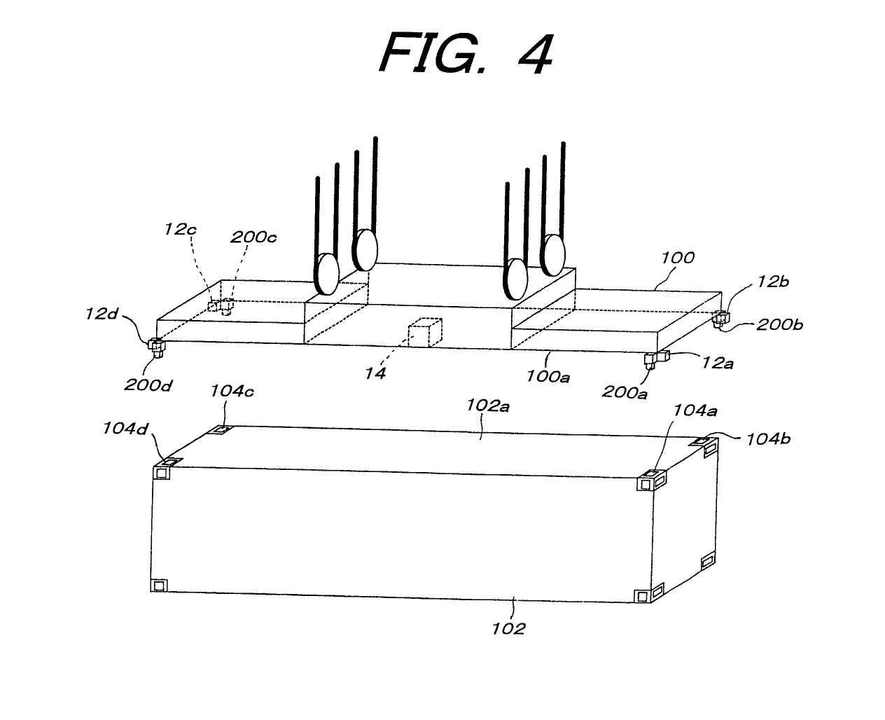

(1) A first preferred embodiment of a detecting system for a container' location according to the present invention will be described by referring to explanatory views of FIGS. 3 and 4 each illustrating the first embodiment of the detecting system according to the invention.

FIG. 3 is a constitutional block diagram showing the detecting system for a container's location according to the first preferred embodiment of the present invention, and FIG. 4 is a perspective view showing constitutions of a variety of instruments in the detecting system for a container's location according to the first preferred embodiment of the invention.

In a detecting system 10 for a container's location according to the first embodiment of the invention, four CCD cameras 200a, 200b, 200c, and 200d are disposed on four corners on a side of the lower surface of a hoisting accessory 100 mounted in a crane for conveying containers such as a container crane, and a transfer crane, respectively, and four illuminating light sources 12a, 12b, 12c, and 12d are disposed in the vicinities of these four CCD cameras 200a, 200b, 200c, and 200d, respectively.

In this case, these CCD cameras 200a through 200d as well as the illuminating light sources 12a through 12d are disposed vertically downward on the hoisting accessory 100 so as to oppose to corner fittings 104a, 104b, 104c, and 104d disposed on four corners on a side of the upper surface 102a of the container 102, respectively.

Specifically, a pair of the CCD camera 200a and the illuminating light source 12a is opposed to the corner fitting 104a, a pair of the CCD camera 200b and the illuminating light source 12b is opposed to the corner fitting 104b, a pair of the CCD camera 200c and the illuminating light source 12c is opposed to the corner fitting 104c, and a pair of the CCD camera 200d and the illuminating light source 12d is opposed to the corner fitting 104d, respectively.

In these circumstances, the illuminating light sources 12a through 12d illuminate vicinities of the corner fittings 104a through 104d placed on the container 102 at the positions opposed to the illuminating light sources 12a through 12d, respectively. Thus, it becomes possible to photograph vicinities of the corner fittings 104a through 104d by means of the associated CCD cameras 200a through 200d each having a pair relationship with each of the illuminating sources 12a through 12d, even if the container 102 is positioned in a dark place.

The four CCD cameras 200a through 200d are synchronized externally to photograph objects at the same time.

In a substantially central region of the under surface 100a of the hoisting accessory 100, a distance finder 14 is disposed vertically downward. The distance finder 14 determines a distance defined between the under surface 100a of the hoisting accessory 100 and the upper surface 102a of the container 102 at the timing when the CCD cameras 200a through 200d take a picture. The result thus determined indicating a distance is output by the distance finder 14 as distance information (photographed distance data).

Video signals (image data) photographed by the CCD cameras 200a through 200d, respectively, are delivered to associated image processors 16a through 16d, respectively.

The image processors 16a through 16d detect two-dimensional coordinates in the respective corresponding corner fitting 104a through 104d regions of the container 102 in accordance with template matching processing. More specifically, a two-dimensional coordinate in the corner fitting 104a region is detected by the image processor 16a, a two-dimensional coordinate in the corner fitting 104b region is detected by the image processor 16b, a two-dimensional coordinate in the corner fitting 104c region is detected by the image processor 16c, and a two-dimensional coordinate in the corner fitting 104d region is detected by the image processor 16d, respectively.

In the detecting system 10 for a container's location, controllers 20a through 20d are further provided so as to correspond to an arithmetic and logic unit 18 as well as to the illuminating light sources 12a and 12d, respectively.

Under the circumstances, the arithmetic and logic unit 18 determines three-dimensional positions and angles of rotation in horizontal plane (skew) on the upper surface of the container 102 with respect to a hoisting accessory 100 by performing arithmetical operations based on the two-dimensional coordinates in the corner fitting 104a through 104d regions detected by the four image processors 16a through 16d and the distance information output from the distance finder 14.

Furthermore, the controllers 20a through 20d are means for regulating emission intensity of the illuminating light sources 12a through 12d based on the distance information obtained by the distance finder 14 through the arithmetic and logic unit 18, and brightness of the video signals photographed by the CCD cameras 200a through 200d, respectively. In the detecting system 10 for a container's location, the controllers 20a through 20d are provided in every four illuminating light sources 12a through 12d.

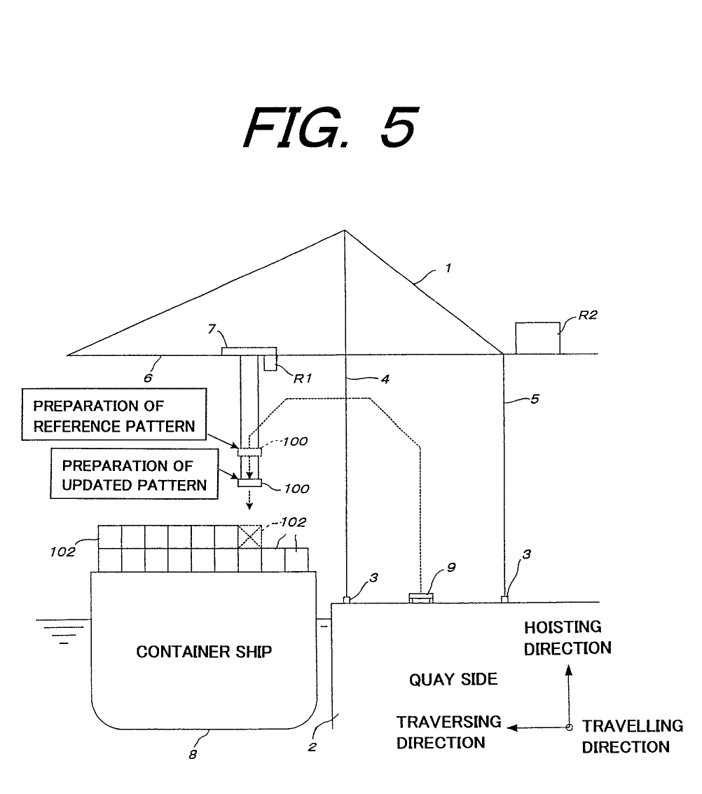

Although the image processors 16a through 16d, the arithmetic and logic unit 18, and the controllers 20a through 20d are not shown in FIG. 4, they may be disposed on the hoisting accessory 100, they may be mounted on either a container crane 1 or a trolley 7, or they may also be installed in a driver's cage R1 (see FIG. 5).

In the following, operations of the detecting system 10 for a container's location will be described by referring to FIGS. 5 through 8.

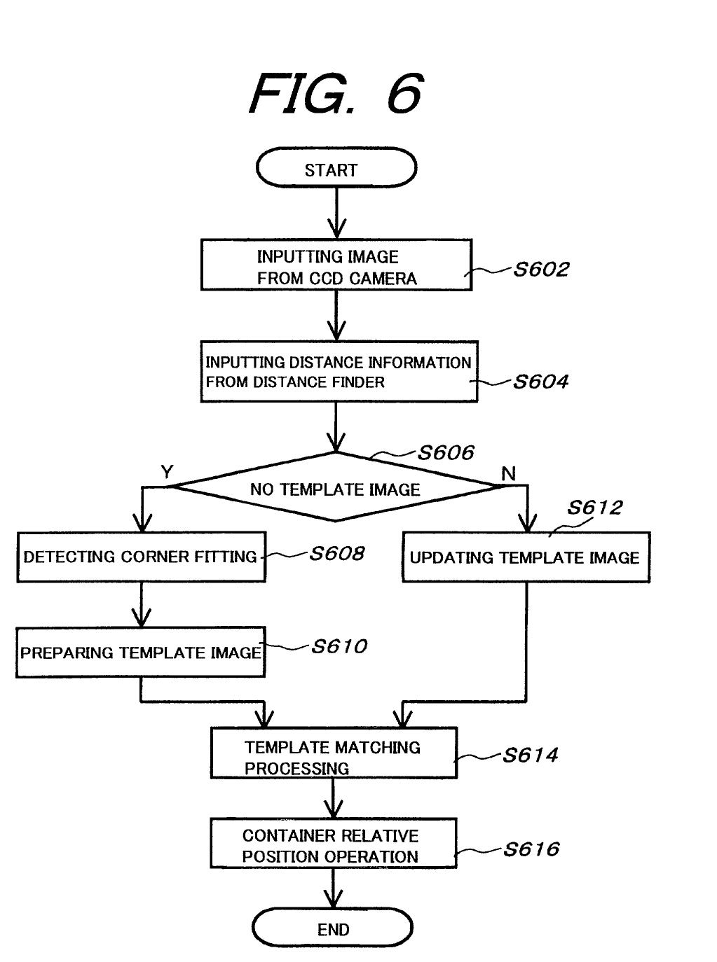

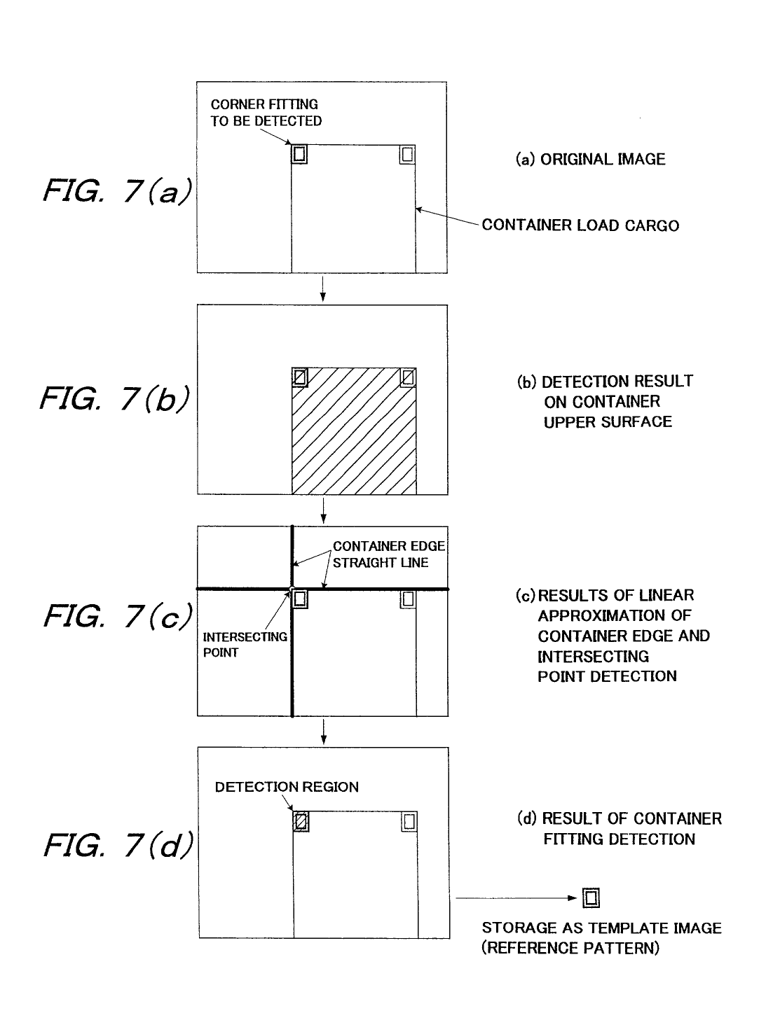

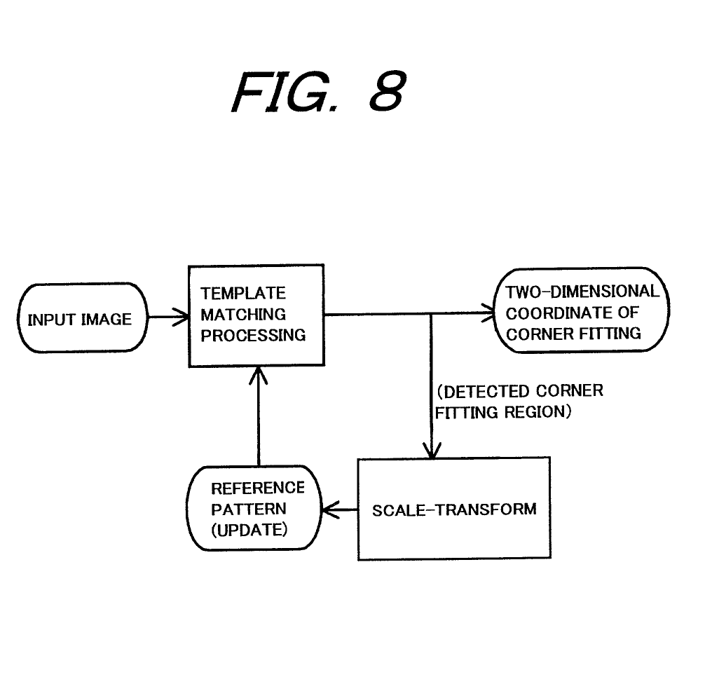

FIG. 5 is an explanatory view showing an entire constitution of a container crane provided with a detecting system 10 for a container's location according to the first embodiment of the present invention, FIG. 6 is a flowchart showing a processing routine executed in the detecting system 10 for a container's location, FIGS. 7(a) through 7(d) are explanatory views each illustrating a manner of detection for a corner fitting 104a through 104d region, and FIG. 8 is an explanatory block diagram showing a process for scale-transforming a template image to update the data.

First, an entire constitution of a container crane provided with the detecting system 10 for a container's location will be described by referring to FIG. 5 wherein the container crane 1 is supported by a leg on ocean side 4 and a leg on land side 5 arranged in transferable manner on a quay side 2 through rails 3.

In this situation, a container 102 to be loaded and unloaded (container load cargo) is suspended by a hoisting accessory 100 supported by a laterally transferable trolley 7 on a girder 6, and the container 102 thus suspended is transferred either from a container ship 8 to a chassis 9, or from the chassis 9 to the container ship 8.

Reference character R1 designates an operator's cage to be boarded by an operator for the container crane 1, and R2 designates a machinery house for containing a variety of power machinery for operating the container crane 1.

In accordance with a well-known art, which has been heretofore known, when rough positional information of the container load cargo 100 is comprehended, the hoisting accessory 100 of the container crane 1 is transferred automatically to substantially midair over the container load cargo 102 (for example, within a range of positioning accuracy of 2 m in midair, and ±300 mm in lateral direction).

In this case, when it is confirmed that the hoisting accessory 100 reached substantially midair over the container load cargo 102 so that an amount of lateral dislocation defined between the hoisting accessory 100 and the container load cargo 102 was within a range of, for example, ±1 m, the detecting system 10 for a container's location according to the present invention starts processing shown in a flowchart of FIG. 6.

In the following, a processing routine executed by the detecting system 10 for a container's location will be described in detail by referring to the flowchart shown in FIG. 6.

When starts the processing shown in the flowchart of FIG. 6, four CCD cameras 200a through 200d photograph a vicinity of the container load cargo 102 residing vertically downward; and the video signals (image data) obtained by the CCD cameras 200a through 200d are input to image processors 16a through 16d (step S602).

Furthermore, a distance defined by the under surface of the hoisting accessory 100 and the upper surface 102a of the container load cargo 102 is determined by a distance finder 14 at the timing when the four CCD cameras 200a through 200d photograph the container load cargo 102; and distance information indicating a distance of the result determined is input to an arithmetic and logic unit 20 (step S604). In this case, the distance finder 14 may be, for example, a laser range finder that determines directly distances, or an instrument, which converts outputs of an encoder mounted on a hoisting drum of a crane into distances, and various types of instruments may properly be utilized.

Then, it is judged whether or not there is a template image of the container load cargo 102 required for template matching processing (step S606).

As a result of the judgment processing in the step S606, when it was judged that no template image of the container load cargo 102 required for template matching processing existed, it proceeds to processing of a step S608 wherein regions of corner fittings 104a through 104d on the upper surface of the container load cargo 102 are detected from the image data photographed by the associated CCD cameras 200a through 200d (a manner for detecting corner fitting 104a through 104d regions will be mentioned hereunder by referring to FIG. 7.).

Thereafter, a template image (reference pattern) required for template matching processing is prepared on the basis of the regions of the corner fittings 104a through 104d detected in the step S608 (step S610).

When the processing in the above-described step S610 is completed, it proceeds to processing of a step S614.

On the other hand, when it was judged that a template image of the container load cargo 102 required for template matching processing existed in judgment processing in the step S606, an operation proceeds to a step S612 wherein the template image is scale-transformed based on a ratio of the distance information at the time when the template image was prepared with respect to the distance information of the image data that was photographed at present, thereby updating the data. The processing for scale-transforming a template image to update the data will be mentioned later by referring to an explanatory block diagram shown in FIG. 8.

When the processing in the above-described step S612 is completed, an operation proceeds to processing in a step S614.

In processing of the step S614, template matching processing (for example, normalized correlation processing) is implemented upon a present image data by employing the template image prepared in the step S610 or the template image updated in the step S612 to specify two-dimensional coordinates in corner fitting 104a through 104d regions on the image data. In this case, the two-dimensional coordinates correspond, for example, to hole central positional coordinates in the corner fittings.

Since each of distances defined between the CCD cameras 200a through 200d and the container load cargo 102, respectively, has been already known as a result of determination by means of the distance finder 14, the two-dimensional coordinates in the corner fitting 104a through 104d regions on the image data obtained in the step S614 can be converted into three-dimensional positional data on the basis of the CCD cameras 200a through 200d. Namely, three-dimensional positional data of the corner fittings 104a through 104d are determined with respect to the image data photographed by the four CCD cameras 200a through 200d, respectively; and finally, a three-dimensional position and an angle of rotation (skew) of the container load cargo 102 are calculated with respect to the hoisting accessory 100 (step S616).

When the processing in the step S616 is finished, the processing routine shown in the flowchart is completed.

The processing routine indicated in the flowchart of the above-described FIG. 6 is repeatedly executed until the hoisting accessory 100 is engaged with the container load cargo 102.

In the following, a method for detecting the corner fitting 104a through 104d regions implemented by means of the image processors 16a through 16d will be described by referring to FIGS. 7(a) through 7(d).

FIG. 7(a) is a view showing video signals (image data: original picture image) photographed by any of the CCD cameras 200 athrough 200d. Since the hoisting accessory 100 is positioned at substantially midair over the container load cargo (for example, ±1 m in a lateral direction), there are the container load cargo 102 and any of the corner fittings 104a through 104d to be detected in substantially the central portion of the image data.

FIG. 7(b) is a view showing a result (a part indicated by oblique lines) obtained by detecting the upper surface 102a region of the container load cargo 102. Detection of the upper surface 102a region of the container load cargo 102 can be realized by, for example, binarizing processing for detecting regions having values equal to or higher than a certain threshold value.

Moreover, FIG. 7(c) is a view showing a condition wherein container edges in the upper surface 102a region of the container load cargo 102 detected as shown in FIG. 7(b) is linearly approximated to detect an intersecting point thereof. As a method for approximating linearly container edges in the upper surface 102a region of the container load cargo 102 detected, for example, Hough transform (reference: e.g., “Handbook of Image Analysis” under the editorship of Mikio Takagi, and Haruhisa Shimoda; Publishing Institute of Tokyo University, p. 572) maybe utilized.

In addition, as another method, when the image signals of FIG. 7(a) are subjected to differential processing, container edges in the upper surface 102a region of the container 102 can be extracted.

FIG. 7(d) is a view showing a detected result of a corner fitting region (a part indicated by slanting lines). In the case where an angle of visibility of the CCD camera, which photographed the image data in FIG. 7(a), and a photographed distance (that is obtained from the distance information determined by the distance finder 14) have been already known, a dimension of one pixel on the image data is determined by calculation. Furthermore, since sizes of the corner fittings 104a through 104d have been fixed, regions of the corner fittings 104a through 104d can be detected on the basis of an intersecting point coordinate of two straight lines on a picture image.

The regions of the corner fittings 104a through 104d detected are maintained inside the corresponding image processors 16a through 16d as template images (reference patterns), respectively.

Thus, corner fitting 104a through 104d regions can be detected in each container load cargo 102 in accordance with the manner shown in FIGS. 7 (a) through 7(d), and template images can be prepared in each container load cargo 102 based on the results detected.

In the following, processing for scale-transforming a template image to update the data obtained will be described by referring to FIG. 8.

Namely, when template matching processing is executed, two-dimensional coordinates of the corner fittings 104a through 104d detected as well as the corner fitting 104a through 104d regions detected are obtained as the outputs. These detected corner fitting 104a through 104d regions are scale-transformed on the basis of a scale transform ratio k, and the resulting data are used as new template images updated. The scale transform ratio k is given by, for example, the following expression (1):

k=(photographed distance of image in corner fitting region detected)/(photographed distance of new input image) (1)

As explained above, if there is a data of photographed distance at the time when an image data (input image) is incorporated into its system, a template image can be updated.

On one hand, when three-dimensional positions of two corner fittings are represented by (x1, y1, z1) and (x2, y2, z2), an angle of rotation (skew) θ of a container load cargo 102 is given by the following expression (2):

tan θ=(y2−y1)/(x2−x1) (2)

wherein x is a lateral direction, y is a travelling direction, and z is a hoisting height direction.

In accordance with a flow of the above-described processing, a three-dimensional position of the container 102 and an angle of rotation (skew) with respect to the hoisting accessory 100 can be sequentially detected.

In case of nighttime, the controllers 20a through 20d are controlled on the basis of distance information determined in the step S604 and brightness of video signals in the CCD cameras 200a through 200d to adjust intensity of illumination from the illuminating light sources 12a through 12d. As described above, when intensity of illumination in the illuminating light sources 12a through 12d is controlled, image data can be photographed under a certain brightness by means of the CCD cameras 200a through 200d even in nighttime. Hence, image data in constant brightness can be obtained.

In the detecting system 10 for a container's location according to the first embodiment of the present invention, there is such a constitution that one each of the image processors 16a through 16d as well as one each of the controllers are disposed with respect to the CCD cameras 200a through 200d as well as the illuminating light sources 12a through 12d, respectively, and hence, it is suitable to position the image processors 16a through 16d as well as the controllers 20a through 20d in the vicinities of the CCD cameras 200a through 200d as well as the illuminating light sources 12a through 12d.

Moreover, in the case where contents or setting as to image processing differ from each other in the CCD cameras 200a through 200d, respectively, maintenance is more easily made in the case where four image processors (16a through 16d) are used. Besides, it is sufficient to prepare four image processors of the same type as the image processors, so that it becomes possible to reduce the cost.

If each of the illuminating light sources 12a through 12d has different characteristics one another, maintenance of the controllers 20a through 20d is easier in case of employing four of them.

Operations of the detecting system 10 for a container's location according to the first preferred embodiment of the present invention have been made as described above.

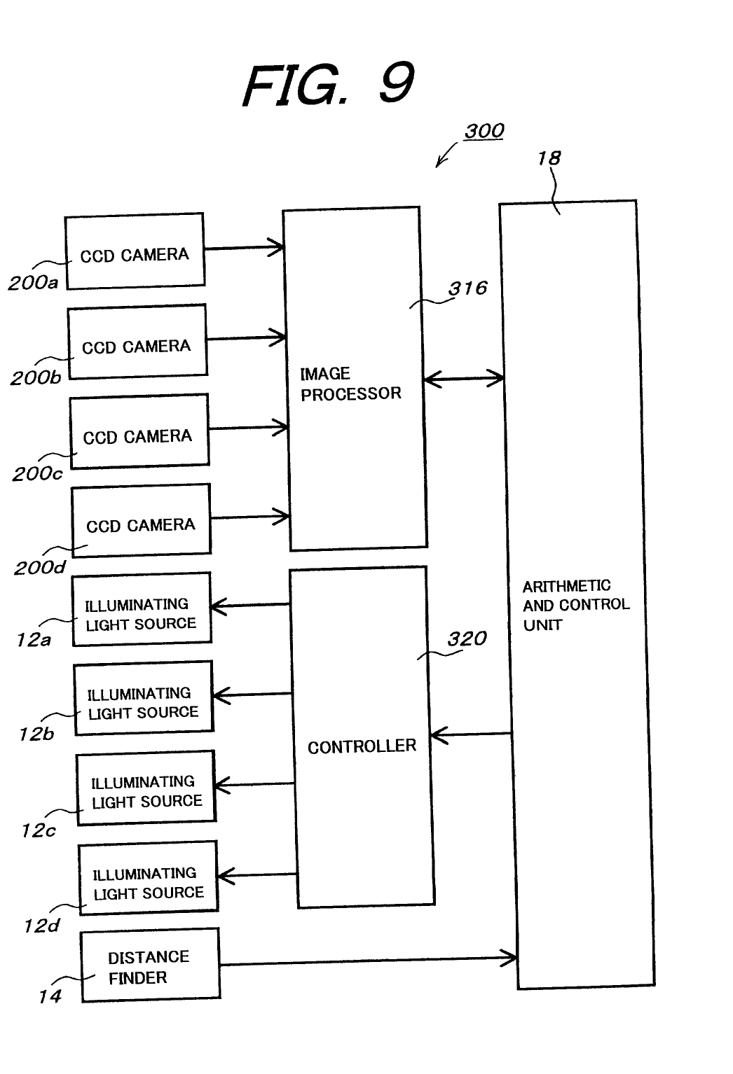

(2) A detecting system for a container's location according to a second preferred embodiment of the invention will be described by referring to FIG. 9 of an explanatory constitutional block diagram showing a detecting system for a container's location according to the second embodiment of the invention.

It is to be noted that a perspective view of FIG. 4 showing constitutions of a variety of instruments in the detecting system for a container's location according to the first embodiment of the invention is quoted as a perspective view showing constitutions of a variety of instruments in the detecting system for a container's location according to the second embodiment of the present invention shown in FIG. 9.

The detecting system 300 for a container's location according to the second embodiment of the invention differs from the above-described detecting system 10 for a container's location according to the first embodiment of the invention in that the detecting system 10 for a container's location comprises the image processors 16a through 16d in every four CCD cameras 200a through 200d, respectively, and comprises further the controllers 20a through 20d in every four illuminating light sources 12a through 12d, respectively, while the detecting system 300 for a container's location has such a constitution that four CCD cameras 200a through 200d are processed by a single image processor 316, and further that four illuminating light sources 12a through 12d are processed by a single controller 320.

In the detecting system 300 for a container's location, video signals photographed by the CCD cameras 200a through 200d, respectively, are output to the single image processor 316.

Then, the image processor 316 detects two-dimensional coordinates in associated corner fitting 104a through 104d regions on a container 102 in accordance with template matching processing. More specifically, the image processor 316 detects each of a two-dimensional coordinate in the corner fitting 104a region corresponding to the CCD camera 200a, a two-dimensional coordinate in the corner fitting 104b region corresponding to the CCD camera 200b, a two-dimensional coordinate in the corner fitting 104c region corresponding to the CCD camera 200c, and a two-dimensional coordinate in the corner fitting 104d region corresponding to the CCD camera 200d, respectively.

Furthermore, the detecting system 300 for a container's location is provided with arithmetic and control unit 18, and the single controller 320.

The arithmetic and control unit 18 determines three-dimensional positions and angles of rotation in horizontal plane (skew) on the upper surface of the container 102 with respect to a hoisting accessory 100 by performing arithmetical operations based on the two-dimensional coordinates in the corner fitting 104a through 104d regions detected by the image processor 316 and distance information determined by a distance finder 14.

Furthermore, the controller 320 is a means for regulating emission intensity of the illuminating light sources 12a through 12d based on the distance information obtained by the distance finder 14 through the arithmetic and logic unit 18, and brightness in the video signals photographed by the CCD cameras 200a through 200d, respectively. In the detecting system 300 for a container's location, the single controller 320 is provided with respect of the four illuminating light sources 12a through 12d.

Although the image processor 316, the arithmetic and logic unit 18, and the controller 320 are not shown in FIG. 4, they may be disposed on the hoisting accessory 100, they may be mounted on either a container crane 1 or a trolley 7, or they may also be installed in a driver's cage R1 (see FIG. 5).

In the following, operations of the detecting system 300 for a container's location will be described, but the operations thereof are essentially the same as that of the above-described detecting system 10 for a container's location, so that detailed explanation therefor is omitted.

The detecting system 300 for a container's location differs from the detecting system 10 for a container's location in that the former detecting system involves the single image processor 316 and the single controller 320, but the difference is essentially in the appearances thereof. In reality, image processing an amount of which corresponds to that to be processed by four image processors (16a through 16d) is performed in parallel in the single image processor 316, and further illumination control of the four illuminating light sources 12a through 12d is performed independently and in a parallel manner in the single controller 320.

According to the detecting system 300 for a container's location, processing of illumination control in the illuminating light sources 12a through 12d can be carried out in common with each other, whereby labor in case of maintenance can be reduced.

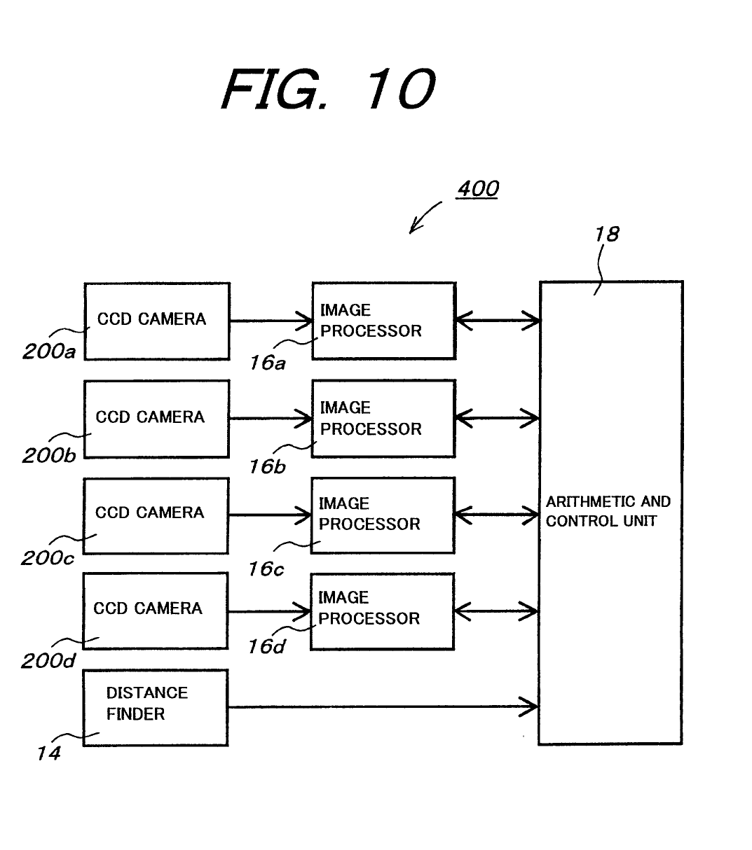

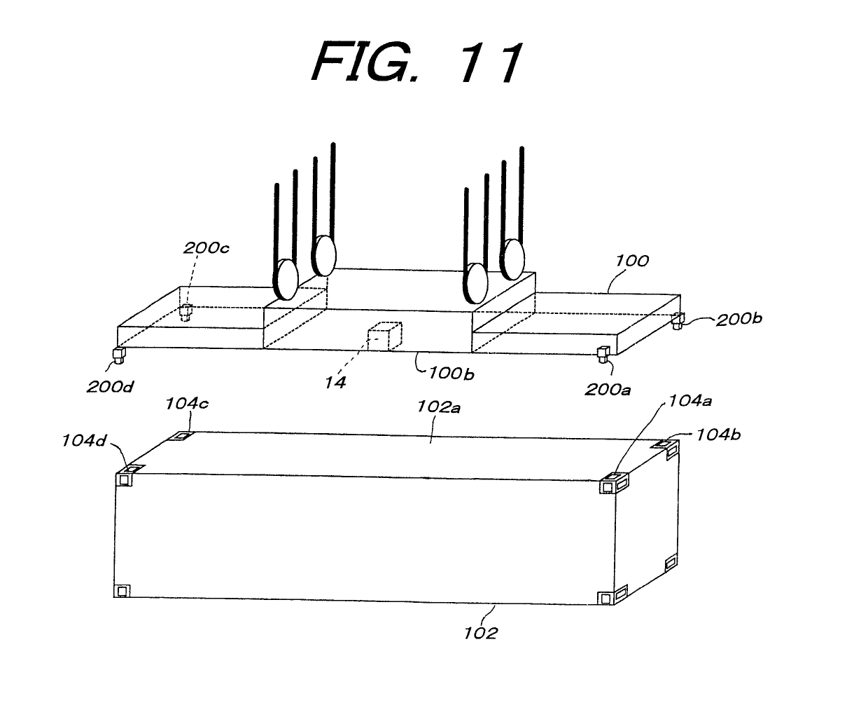

(3) A detecting system for a container's location according to a third preferred embodiment of the present invention will be described by referring to FIGS. 10 and 11 of an explanatory diagram and an explanatory view each for explaining the detecting system for a container's location according to the third embodiment of the invention.

FIG. 10 is a constitutional block diagram showing the detecting system for a container's location according to the third preferred embodiment of the invention; and FIG. 11 is a perspective view showing constitutions of a variety of instruments in the detecting system for a container's location according to the third preferred embodiment of the invention.

The detecting system 400 for a container's location according to the third embodiment of the invention differs from the above-described detecting system 10 for a container's location according to the first embodiment of the invention in that the detecting system 10 for a container's location is provided with the four illuminating light sources 12a through 12d, and the four controllers 20a through 20d corresponding to the four illuminating light sources 12a through 12d, while the detecting system 400 for a container's location is not provided with any of such instruments.

In the detecting system 400 for a container's location according to the third embodiment of the invention, four CCD cameras 200a, 200b, 200c, and 200d are disposed on four corners on a side of the lower surface 100a of a hoisting accessory 100 mounted in a container crane 1, or a transfer crane, respectively.

In this case, these CCD cameras 200a through 200d are disposed vertically downward on the hoisting accessory 100 so as to oppose to corner fittings 104a, 104b, 104c, and 104d disposed on four corners on a side of the upper surface 102a of the container 102, respectively. Specifically, the CCD camera 200a photographs a vicinity of the corner fitting 104a on the container 102, the CCD camera 200b photographs a vicinity of the corner fitting 104b on the container 102, the CCD camera 200c photographs a vicinity of the corner fitting 104c on the container 102, and the CCD camera 200d photographs a vicinity of the corner fitting 104d on the container 102, respectively.

Namely, the detecting system 400 for a container's location according to the third embodiment of the invention differs from the detecting system 10 for a container's location according to the first embodiment of the invention as well as from the detecting system 300 for a container's location according to the second embodiment of the invention in that no particular illuminating light source (for example, the illuminating light sources 12a through 12d or the like) is disposed on the hoisting accessory 100. However, this does not mean that brightness is not entirely required, but there is such an assumption that sufficient brightness can be obtained by an illuminating light source (e.g., mercury lamp), which has been heretofore mounted on the container crane 1 and the like. When brightness is not sufficient, a required illuminating light source must be mounted on a main body of the container crane 1.

The four CCD cameras 200a through 200d photograph objects at the same timing by means of an external synchronizing mechanism.

Although image processors 16a through 16, and an arithmetic and logic unit 18 are not shown in FIG. 11, they may be disposed on the hoisting accessory 100, they may be mounted on either a container crane 1 or a trolley 7, or they may also be installed in a driver's cage R1 (see FIG. 5).

In the following, operations of the detecting system 400 for a container's location will be described, but the operations thereof are essentially the same as that of the above-described detecting system 10 for a container's location, so that detailed explanation therefor is omitted.

The detecting system 400 for a container's location differs merely from the detecting system 10 for a container's location in that the former detecting system is not provided with any of the illuminating light sources 12a through 12d and any of the controllers 20a through 20d.

Accordingly, only processing excluding that as to the illuminating light sources 12a through 12d and the controllers 20a through 20d in the detecting system 10 for a container's location is implemented in the detecting system 400 of a container's location.

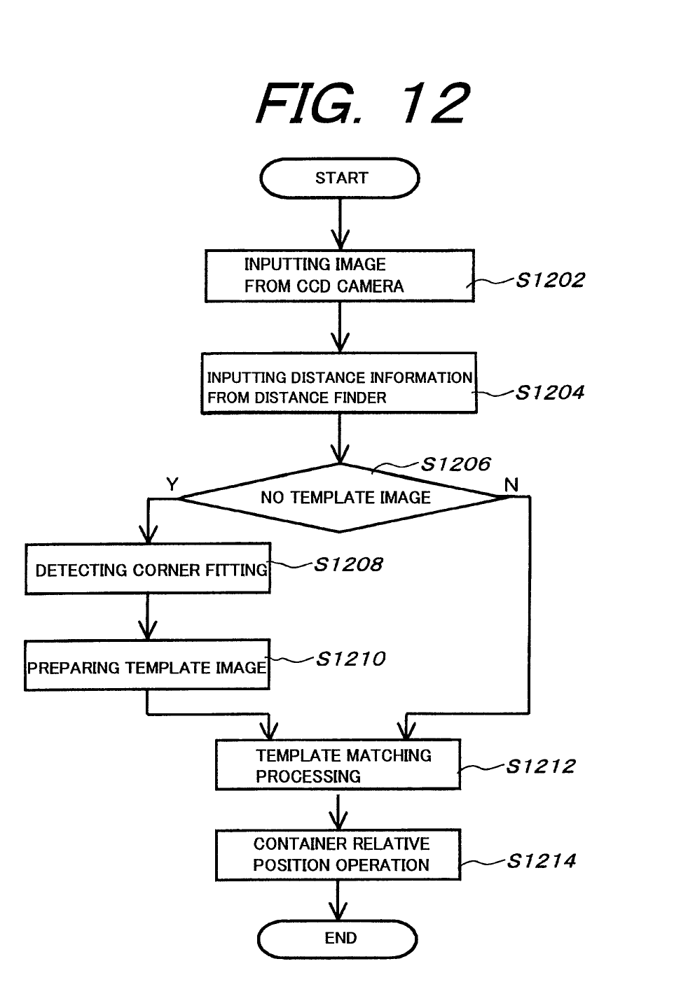

(4) A detecting system for a container's location according to a fourth preferred embodiment of the present invention will be described by referring to FIG. 12 for explaining the detecting system for a container's location according to the fourth preferred embodiment of the invention.

The detecting system for a container's location according to the fourth embodiment of the invention is the one, which has been modified to involve a function for adjusting automatically a photographing magnification in the CCD cameras 200a through 200d based on distance information (measured data) determined by a distance finder 14 in the respective detecting systems for a container's location according to the first to third embodiments of the present invention.

Accordingly, a constitutional block diagram illustrating the detecting system for a container's location of the fourth embodiment and a perspective view showing constitutions of a variety of instruments in the detecting system for a container's location according to the fourth embodiment of the invention are the same as the constitutional block diagrams showing the above-described detecting systems of the first through third embodiments according to the invention (FIGS. 3, 9, and 10) and the perspective views showing constitutions of a variety of instruments in the detecting systems of the first through third embodiments according to the invention (FIGS. 4, and 11), so that the block diagrams and the perspective views of the first through third embodiments of the invention are quoted herein and the explanation therefor is omitted.

In a prior art, if general positional information of a container load cargo 102 has been grasped as shown in FIG. 5, a hoisting accessory 100 of a container crane 1 can be transferred automatically over substantially midair of the container load cargo 102 (there is a margin of error in a lateral direction of around ±200 mm to ±300 mm).

When the hoisting accessory 100 reaches over substantially midair of the container load cargo 102, so that when it is confirmed that a discrepancy in traversing motion defined between the hoisting accessory 100 and the container load cargo 102 reaches within, for example, ±1 m, the detecting system for a container's location according to the fourth embodiment of the present invention starts processing shown in a flowchart of FIG. 12.

In the following, a processing routine executed by the detecting system for a container's location of the fourth embodiment according to the invention will be described in detail by referring to the flowchart shown in FIG. 12.

When the processing shown in the flowchart of FIG. 12 is started, four CCD cameras 200a through 200d photograph vicinities of the container load cargo 102 residing vertically downward; and video signals (image data) photographed by the CCD cameras 200a through 200d are input to an image processor (step S1202).

Furthermore, a distance defined between the under surface 100a of the hoisting accessory 100 and the upper surface 102a of the container load cargo 102 is defined by a distance finder 14 at each photographing timing in the four CCD cameras 200a through 200d; and distance information indicating distances being results of the determination is input to an arithmetic and logic unit (step S1204). In this case, the distance finder 14 may be, for example, a laser range finder that determines directly distances, or an instrument, which converts outputs of an encoder mounted on a hoisting drum of a crane into distances, and various types of instruments may properly be utilized.

Then, it is judged whether or not there is a template image of the container load cargo 102 required for template matching processing (step S1206).

As a result of the judgment processing in the step S1206, when it was judged that no template image of the container load cargo 102 required for template matching processing existed, operation proceeds to processing of a step S1208 wherein regions of corner fittings 104a through 104d on the upper surface 102a of the container load cargo 102 are detected from the video signals (image data) photographed by the associated CCD cameras 200a through 200d (concerning a manner for detecting corner fitting 104a through 104d regions, the above-described explanation made by referring to FIG. 7 is quoted herein).

Thereafter, a template image (reference pattern) required for template matching processing is prepared on the basis of the regions of the corner fittings 104a through 104d detected in the step S1208 (step S1210).

When the processing in the above-described step S1210 is completed, it proceeds to processing of a step S1212.

On the other hand, when it was judged that a template image of the container load cargo 102 required for template matching processing existed, an operation proceeds to a step S1212.

In processing of the step S1212, template matching processing (for example, normalized correlation processing) is implemented upon present video signals (image data) by employing the template image to specify two-dimensional coordinates in corner fitting 104a through 104d regions on the video signals (image data). In this case, the two-dimensional coordinates correspond, for example, to hole central positional coordinates in the corner fittings.

Since each of distances defined between the CCD cameras 200a through 200d and the container load cargo 102, respectively, has been already known as a result of determination by means of the distance finder 14, the two-dimensional coordinates in the corner fitting 104a through 104d regions on the image data obtained in the step S1212 can be converted into three-dimensional positional data on the basis of the CCD cameras 200a through 200d. Namely, three-dimensional positional data of the corner fittings 104a through 104d are determined with respect to the video signals (image data) photographed by the four CCD cameras 200a through 200d, respectively; and finally, a three-dimensional position and an angle of rotation (skew) of the container load cargo 102 are calculated with respect to the hoisting accessory 100 (step S1214).

When the processing in the step S1214 is finished, the processing routine shown in the flowchart is completed.

The processing routine indicated in the flowchart of the above-described FIG. 12 is repeatedly executed until the hoisting accessory 100 is engaged with the container load cargo 102.

In accordance with the processing routine as described above, a three-dimensional position and an angle of rotation (skew) of the container load cargo 102 can be sequentially detected with respect to the hoisting accessory 100.

The detecting system for a container's location according to the fourth embodiment of the present invention differs from that of the first to the third embodiments in that the former detecting system involves a function to automatically adjust a magnification of photographing based on the distance information (measured data) determined by the distance finder 14. Thus, dimensions of the corner fitting 104a through 104d regions on the image data photographed by the CCD cameras 200a through 200d become substantially constant, so that there is no need of updating template images in the fourth embodiment. This is a significant characteristic in the detecting system for a container's location according to the fourth embodiment of the present invention.

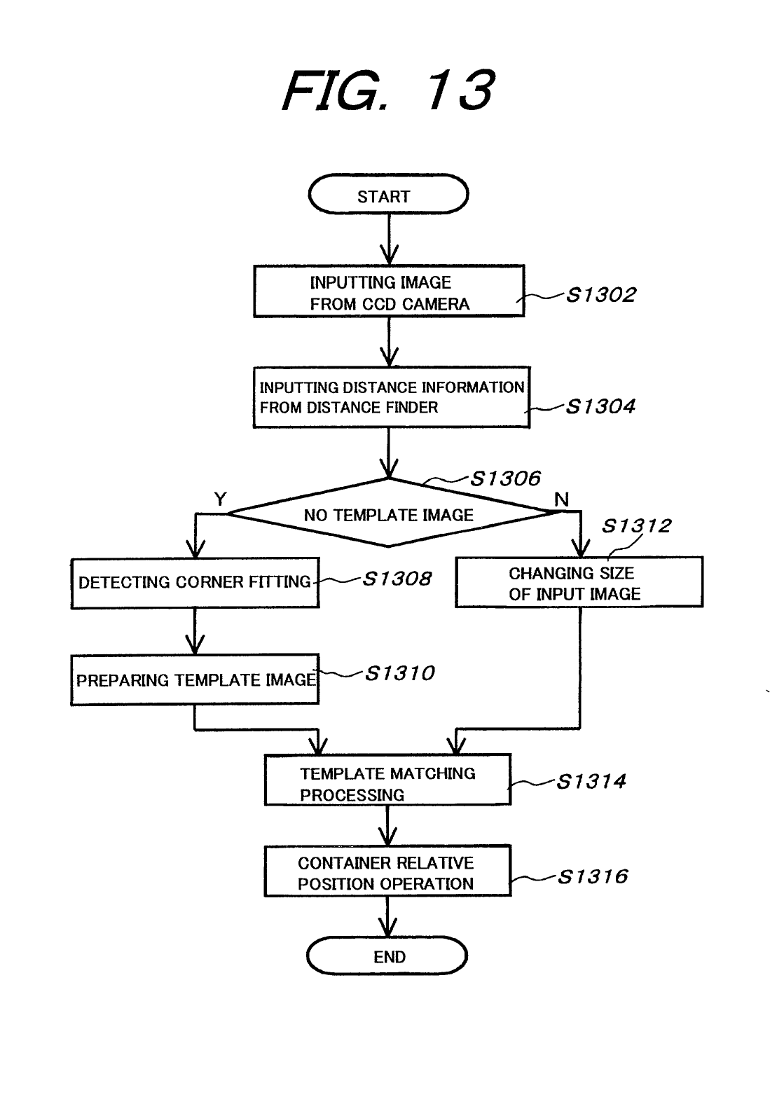

(5) A detecting system for a container's location according to a fifth embodiment of the present invention will be described by referring to FIGS. 13, 14, and 15 for explaining the detecting system for a container's location according to the fifth embodiment of the invention, respectively.

The detecting system for a container's location of the fifth embodiment according to the present invention is the one wherein a manner for processing made by the image processors (16a through 16d, and 316) is modified so as to differ from that of the above-described detection systems of the first to third embodiments according to the invention.

Accordingly, a constitutional block diagram illustrating the detecting system for a container's location of the fifth embodiment and a perspective view showing constitutions of a variety of instruments in the detecting system for a container's location of the fifth embodiment according to the invention are the same as the constitutional block diagrams showing the above-described detecting systems of the first through third embodiments according to the invention (FIGS. 3, 9, and 10) and the perspective views showing constitutions of a variety of instruments in the detecting systems of the first through third embodiments according to the invention (FIGS. 4, and 11), so that the block diagrams and the perspective views of the first through third embodiments of the invention are quoted herein and the explanation therefor is omitted.

Different points in the detecting system for a container's location of the fifth embodiment according to the invention from that of the first to third embodiments will be described hereunder.

In a prior art, when general positional information of a container load cargo 102 is grasped as shown in FIG. 5, a hoisting accessory 100 of a container crane 1 is transferred automatically over substantially midair of the container load cargo 102 (a margin of error in a lateral direction is within ±300 mm).

When the hoisting accessory 100 reaches over substantially midair of the container load cargo 102, so that when it is confirmed that a discrepancy in traversing motion defined between the hoisting accessory 100 and the container load cargo 102 reaches within, for example, ±1 m, the detecting system for a container's location of the fifth embodiment according to the present invention starts processing shown in a flowchart of FIG. 13.

In the following, a processing routine executed by the detecting system for a container's location of the fifth embodiment according to the invention will be described in detail by referring to the flowchart shown in FIG. 13.

When the processing shown in the flowchart of FIG. 13 is started, four CCD cameras 200a through 200d photograph vicinities of the container load cargo 102 residing vertically downward; and video signals (image data) photographed by the CCD cameras 200a through 200d are input to an image processor (step S1302).

Furthermore, a distance extending from a distance finder 14 to the container load cargo 102 positioned vertically downward therefrom is defined by the distance finder 14 at each photographing timing in the four CCD cameras 200a through 200d; and distance information indicating distances being results of the determination is input to an arithmetic and logic unit (step S1304). In this case, the distance finder 14 maybe, for example, a laser range finder that determines directly distances, or an instrument, which converts outputs of an encoder mounted on a hoisting drum of a crane into distances, and various types of instruments may properly be utilized.

Then, it is judged whether or not there is a template image of the container load cargo 102 required for template matching processing (step S1306).

As a result of the judgment processing in the step S1306, when it was judged that no template image of the container load cargo 102 required for template matching processing existed, operation proceeds to processing of a step S1308 wherein regions of corner fittings 104a through 104d on the upper surface 102a of the container load cargo 102 are detected from the image data photographed by the associated CCD cameras 200a through 200d (concerning a manner for detecting corner fitting 104a through 104d regions, the above-described explanation made by referring to FIG. 7 is quoted herein).

Thereafter, a template image (reference pattern) required for template matching processing is prepared on the basis of the regions of the corner fittings 104a through 104d detected in the step S1308 (step S1310).

When the processing in the above-described step S1310 is completed, operation proceeds to processing of a step S1312.

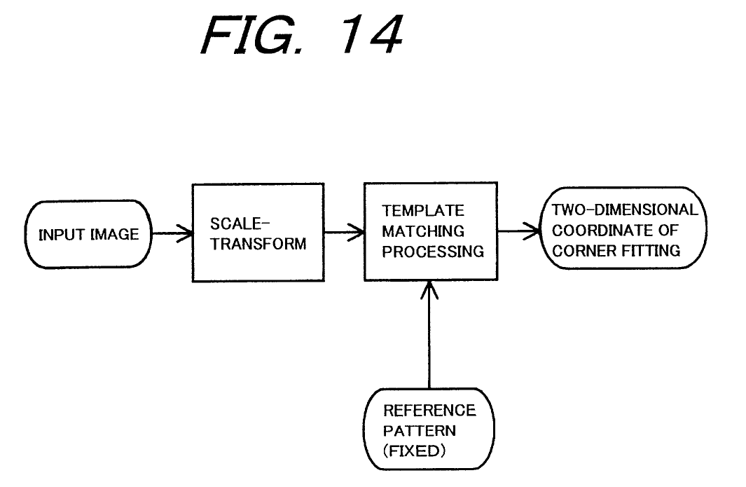

On the other hand, when it was judged that a template image of the container load cargo 102 required for template matching processing existed, an operation proceeds to a step S1312 wherein an input image is scale-transformed based on a ratio of the distance information at the time when the template image was prepared with respect to the distance information of the image data that was photographed at present, thereby making the data to match with a size of template image (Details of the processing for changing a size of an input image in the step S1312 will be mentioned later by referring to FIG. 14).

When the processing in the above-described step S1312 is completed, an operation proceeds to processing in a step S1314.

In processing of the step S1314, template matching processing (for example, normalized correlation processing) is implemented upon image data scale-transformed by employing the template image prepared in the step S1310 to specify two-dimensional coordinates in corner fitting 104a through 104d regions on the image data. In this case, the two-dimensional coordinates correspond, for example, to hole central positional coordinates in the corner fittings.

Since each of distances defined between the CCD cameras 200a through 200d and the container load cargo 102, respectively, has been already known as a result of determination by means of the distance finder 14, the two-dimensional coordinates in the corner fitting 104a through 104d regions on the image data obtained in the step S1314 canbe converted into three-dimensional positional data on the basis of the CCD cameras 200a through 200d. Namely, two-dimensional positional data of the corner fittings 104a through 104d are determined with respect to the image data photographed by the four CCD cameras 200a through 200d, respectively; and finally, a three-dimensional position and an angle of rotation (skew) of the container load cargo 102 are calculated with respect to the hoisting accessory 100 (step S1316).

When the processing in the step S1316 is finished, the processing routine shown in the flowchart is completed.

The processing routine indicated in the flowchart of the above-described FIG. 13 is repeatedly executed until the hoisting accessory 100 is engaged with the container load cargo 102.

In the following, details of the processing for changing a size of the input image in the above-described step S1312 will be described by referring to FIG. 14.

An input image is scale-transformed on the basis of a scale transform ratio h wherein the scale transform ratio is given by, for example, the following expression (3):

h=(photographing distance in new input image)/(photographing distance in image of detected corner fitting region) (3)

As mentioned above, when photographing distance data at the time of taking an input image (image data) is known, a size of the input image can match with that of a template image.

When the detecting system for a container's location of the fifth embodiment according to the present invention is compared with that of the first embodiment, the shorter photographing distance results in the larger size of template image in the first embodiment, while a size of template image is constant in the fifth embodiment. Since a time required for template matching processing is correlative with a size of template image, there is such a tendency that a processing time increases gradually in the first embodiment, while a processing time can be kept substantially constant in the fifth embodiment.

For this reason, the above-described fifth embodiment is effective in the case where it is required to reduce a processing time.

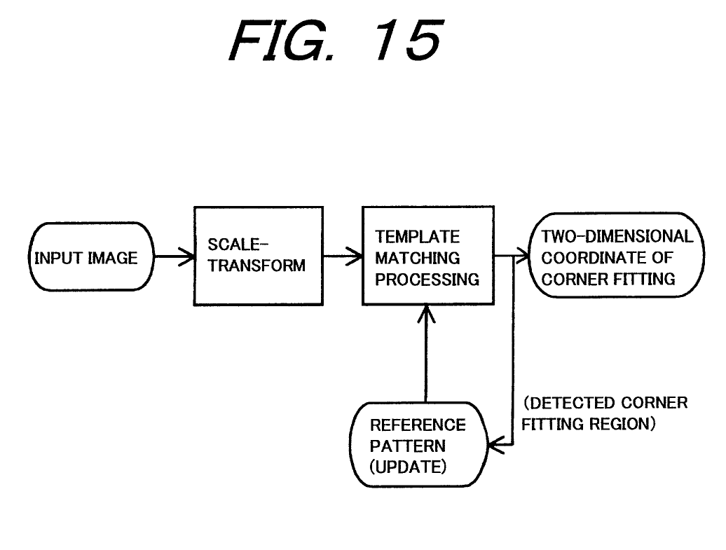

In this respect, processing of FIG. 8 may be combined with that of FIG. 14 as shown in FIG. 15.

Operations in the detecting system for a container's location of the fifth embodiment according to the present invention are that as mentioned above.

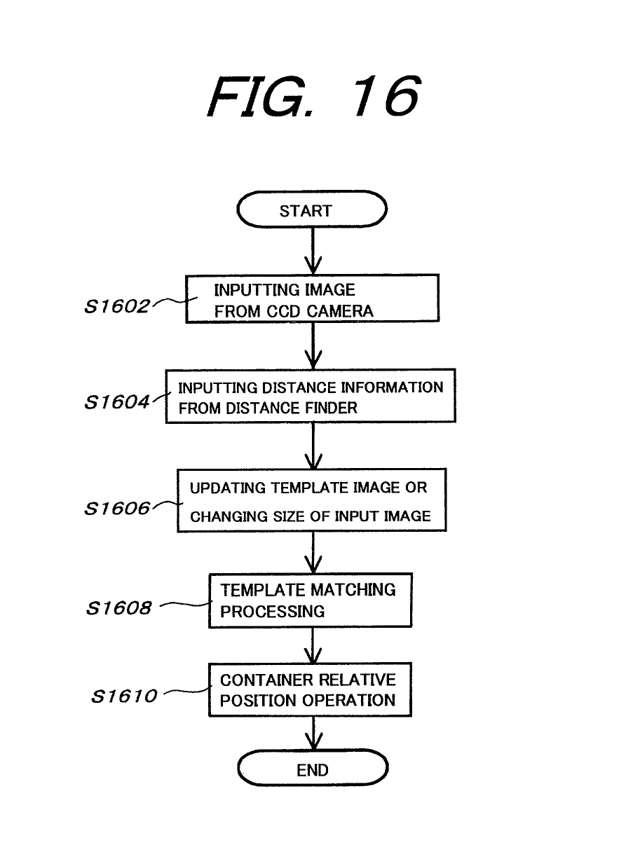

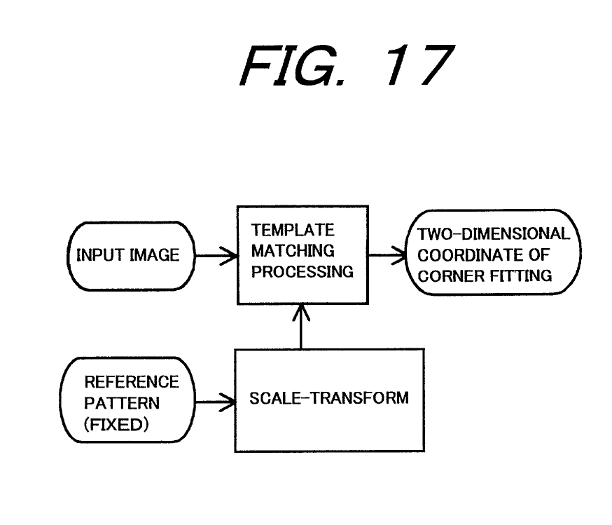

(6) A detecting system for container's location of a sixth embodiment according to the present invention will be described by referring to FIGS. 16 and 17 for explaining the detecting system for a container's location of the sixth embodiment according to the invention, respectively.

The detecting system for a container's location of the sixth embodiment according to the present invention is the one wherein a manner for processing made by the image processors (16a through 16d, and 316) is modified so as to differ from that of the above-described detection systems of the first to third embodiments according to the invention.

Accordingly, a constitutional block diagram illustrating the detecting system for a container's location of the sixth embodiment and a perspective view showing constitutions of a variety of instruments in the detecting system for a container's location of the sixth embodiment according to the invention are the same as the constitutional block diagrams showing the above-described detecting systems of the first through third embodiments according to the invention (FIGS. 3, 9, and 10) and the perspective views showing constitutions of a variety of instruments in the detecting systems of the first through third embodiments according to the invention (FIGS. 4, and 11), so that the block diagrams and the perspective views of the first through third embodiments of the invention are quoted herein and the explanation therefor is omitted.

In the following, operations of the detecting system for a container's location of the sixth embodiment according to the present invention will be described by referring to FIGS. 16 and 17 wherein the characteristic features of the sixth embodiment reside in that one or a plurality of images of corner fittings 104a through 104d on the upper surface of a container 102 in response to distance information between a hoisting accessory 100 and a container load cargo 102 have been previously prepared as template image(s). In the case where the plurality of template images are prepared, for example, they may be a plural number of template images for sunshine use, template images for shady use, template images for nighttime use, and template images for the like uses. When such template images are prepared, it maybe considered that, for example, averaged images of the plurality of corner fittings are adopted.

In a prior art, when general positional information of a container load cargo 102 is grasped as shown in FIG. 5, a hoisting accessory 100 of a container crane 1 is transferred automatically over substantially midair of the container load cargo 102 (a margin of error in a lateral direction is within ±300 mm).

When the hoisting accessory 100 reaches over substantially midair of the container load cargo 102, so that when it is confirmed that a discrepancy in traversing motion defined between the hoisting accessory 100 and the container load cargo 102 reaches within, for example, ±1 m, the detecting system for a container's location of the sixth embodiment according to the present invention starts processing shown in FIG. 16.

In the following, a processing routine executed by the detecting system for a container's location of the sixth embodiment according to the invention will be described in detail by referring to the flowchart shown in FIG. 16.

When the processing shown in the flowchart of FIG. 16 is started, four CCD cameras 200a through 200d photograph vicinities of the container load cargo 102 residing vertically downward; and video signals (image data) photographed by the CCD cameras 200a through 200d are input to an image processor (step S1602).

Furthermore, a distance extending from a distance finder 14 to the container load cargo 102 positioned vertically downward therefrom is defined by the distance finder 14 at each photographing timing in the four CCD cameras 200a through 200d; and distance information indicating distances being results of the determination is input to an arithmetic and logic unit (step S1604). In this case, the distance finder 14 maybe, for example, a laser range finder that determines directly distances, or an instrument, which converts outputs of an encoder mounted on a hoisting drum of a crane into distances, and various types of instruments may properly be utilized.

Then, template images (reference patterns) are scale-transformed on the basis of distance information obtained by the distance finder 14 to update the template images, or sizes of input images are scale-transformed on the basis of distance information obtained by the distance finder 14 (step S1606). In this case, either of a step for scale-transforming the template images to update the data, or a step for scale-transforming sizes of the input images has been previously set up.

In this respect, processing for scale-transforming template images to update the data is shown in FIG. 17.

On one hand, the above-described explanation made by referring to FIG. 14 is quoted as to processing for scale-transforming sizes of input images.

Thereafter, template matching processing (for example, normalized correlation processing) is implemented upon the present image data by employing the template images updated or input images sizes of which were changed in the step S1606 to specify two-dimensional coordinates in corner fitting 104a through 104d regions on the image data (step S1608). In this case, the two-dimensional coordinates correspond, for example, to hole central positional coordinates in the corner fittings.

Since each of distances defined between the CCD cameras 200a through 200d and the container load cargo 102, respectively, has been already known as a result of determination by means of the distance finder 14, the two-dimensional coordinates in the corner fitting 104a through 104d regions on the image data obtained in the step S1608 can be converted into three-dimensional positional data on the basis of the CCD cameras 200a through 200d. Namely, two-dimensional positional data of the corner fittings 104a through 104d are determined with respect to the image data photographed by the four CCD cameras 200a through 200d, respectively; and finally, a three-dimensional position and an angle of rotation (skew) of the container load cargo 102 are calculated with respect to the hoisting accessory 100 (step S1610).

When the processing in the step S1610 is finished, the processing routine shown in the flowchart is completed.

The processing routine indicated in the flowchart of the above-described FIG. 16 is repeatedly executed until the hoisting accessory 100 is engaged with the container load cargo 102.

When the detecting system for container's location of the sixth embodiment according to the present invention is compared with that of the fifth embodiment, a difference is in that template images have been previously prepared in the sixth embodiment. As a result, there is such an advantage that an unlikely error in preparation of template images can be excluded in advance.

Operations in the detecting systemfor a container's location of the sixth embodiment according to the present invention are that as mentioned above.

Thus, the following advantages are obtained in accordance with the above-described detecting systems of the various preferred embodiments according to the present invention.

(a) Containers 102 being objects to be detected in the present invention have a great variety of colors. Moreover, corner fittings 104a through 104d should have been essentially coated with the same coating as that with which the surface of a container 102 has been coated. In this respect, however, the coating had been irregularly peeled off from the corner fittings 104a through 104d in most cases, because a hoisting accessory 100 is in direct contact with these corner fittings 104a through 104d in the case when the container 102 is handled with the hoisting accessory 100.

As mentioned above, the corner fittings 104a through 104d being objects to be detected in template matching processing have great varieties of colors applied, besides, there are many cases wherein a coating applied had been irregularly peeled off. Accordingly, it is difficult to previously prepare typical template images (reference patterns) in the execution of template matching processing in most cases.

In this respect, according to the embodiments of the present invention, it is arranged in such that a container load cargo 102 is photographed; corner fitting 104a through 104d regions are detected by means of image processing; and template images are prepared in each container load cargo 102 from the resulting images in the case where a distance between a hoisting accessory 100 and the container load cargo is distant (long). As a result, the present invention has such a characteristic and an advantage that template matching processing can be positively performed with respect to a container 102 in any condition.

(b) In template matching processing, when sizes of objects to be detected vary, detection error increases, and there arise erroneous detection and incapability of detection in the worst case due to a principle in the processing.

Furthermore, since a distance between a container crane or a transfer crane and a container load cargo changes sequentially in a detecting system for a container's location, it is difficult to avoid changes in sizes of objects to be detected on their images.

On the other hand, according to the embodiments of the present invention, it was made possible to implement template matching processing in accordance with such a manner that template images are scale-transformed on the basis of a photographing distance data in case of preparing the present template image and a photographing distance data in case of future processing of image data.

Therefore, the embodiments of the present invention have such a significant advantage that application of template matching processing becomes possible in a detecting system for a container's location.

(c) Due to a principle reason in template matching processing, when sizes of objects to be detected vary, detection error increases, and there arises erroneous detection or incapability of detection in the worst case.

Besides, a distance between a hoisting accessory of a container crane or a transfer crane and a container load cargo changes sequentially in a detecting system for a container's location, so that it is difficult to avoid changes in sizes of objects to be detected on their images.

On the other hand, according to the embodiments of the present invention, it was made possible to implement template matching processing in accordance with such a manner that template images are scale-transformed on the basis of a photographing distance data in case of preparing the present template image and a photographing distance data in case of future processing of image data.

Therefore, the embodiments of the present invention have such a significant advantage that application of template matching processing becomes possible in a detecting system for a container's location.

(d) Due to a principle reason in template matching processing, when sizes of objects to be detected vary, detection error increases, and there arises erroneous detection or incapability of detection in the worst case.

Besides, a distance between a hoisting accessory of a container crane or a transfer crane and a container load cargo changes sequentially in a detecting system for a container's location, so that it is difficult to avoid changes in sizes of objects to be detected on their images.

On the other hand, according to the embodiments of the present invention, it was made possible to keep a size of an object to be detected constant on its image in accordance with such a manner that a photographing magnification in CCD cameras is changed on the basis of distance measuring data of a distance finder, even if a distance between the hoisting accessory of a container crane or a transfer crane and the container load cargo varies.

Therefore, the embodiments of the present invention have such a significant advantage that performance of template matching processing becomes possible without updating template image.

(e) Illuminating light sources are required to photograph a container load cargo in nighttime or a dark place. In this respect, if illuminating light sources have been mounted on a hoisting accessory of a container crane or a transfer crane, illumination intensity for the container load cargo changes, when a distance between the hoisting accessory and the container load cargo changes.

On the other hand, according to the embodiments of the present invention, it was made possible that intensities of illumination in illuminating light sources are controlled on the basis of distance measuring data of a distance finder and brightness of video signals in CCD cameras, whereby illumination intensity is kept constant on the surface of the container load cargo.

Therefore, the embodiments of the present invention have such a significant advantage that template matching processing can be implemented stably, since image data, which has always constant brightness even in nighttime or a dark place can be obtained.

(f) According to the embodiments of the present invention, it is arranged in such that when a distance between a hoisting accessory and a container load cargo is distant (long), the container load cargo is photographed; corner fitting regions are detected by means of image processing; and template images are prepared in each container load cargo from the resulting images. However, there is no assurance of arising detection error for corner fitting regions. Thus, one or plural typical template image(s) (reference pattern(s)) corresponding to a distance(s) (photographing distance(s)) between a hoisting accessory and a container load cargo(s) has (have) been prepared. As a result, the embodiments of the present invention have such a characteristic and advantage that template matching processing can positively be executed.

(7) Other embodiments of the image processors 16a through 16d

By means of a manner with the use of image processors 16a through 16d in a detecting system for a container's location (see FIG. 7 and the explanation therefor) mentioned in the above-described respective embodiments (the first to the sixth embodiments) according to the present invention, there is a possibility of erroneous detection of a contour line of a container load cargo 102 in the case where a ghost parallel to the contour line of the container load cargo 102 appears due to a photographing condition and the like.

In such a case, when a contour line on the upper surface 102a of the container was erroneously detected, there was such a fear that a region quite different from the corner fittings 104a through 104d was recognized as a template image.

In order to eliminate such fear as described above, an image processor by which an appropriate template image can be prepared even in a case where a ghost, particularly, the one parallel to a contour line of a container load cargo appears according to a photographing condition and the like will be described hereunder. The image processor, which will be described hereinafter, may be combined with a detection system for a container's location of any of the above-described respective embodiments (the first to the sixth embodiments) according to the present invention.

(7-1) A first other embodiment for image processors 16a through 16d

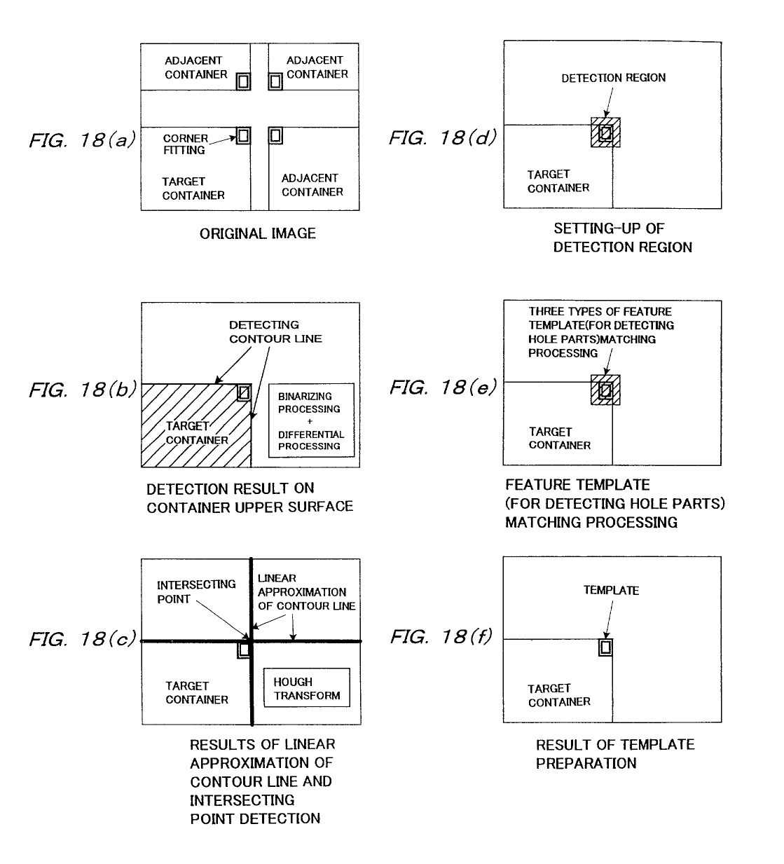

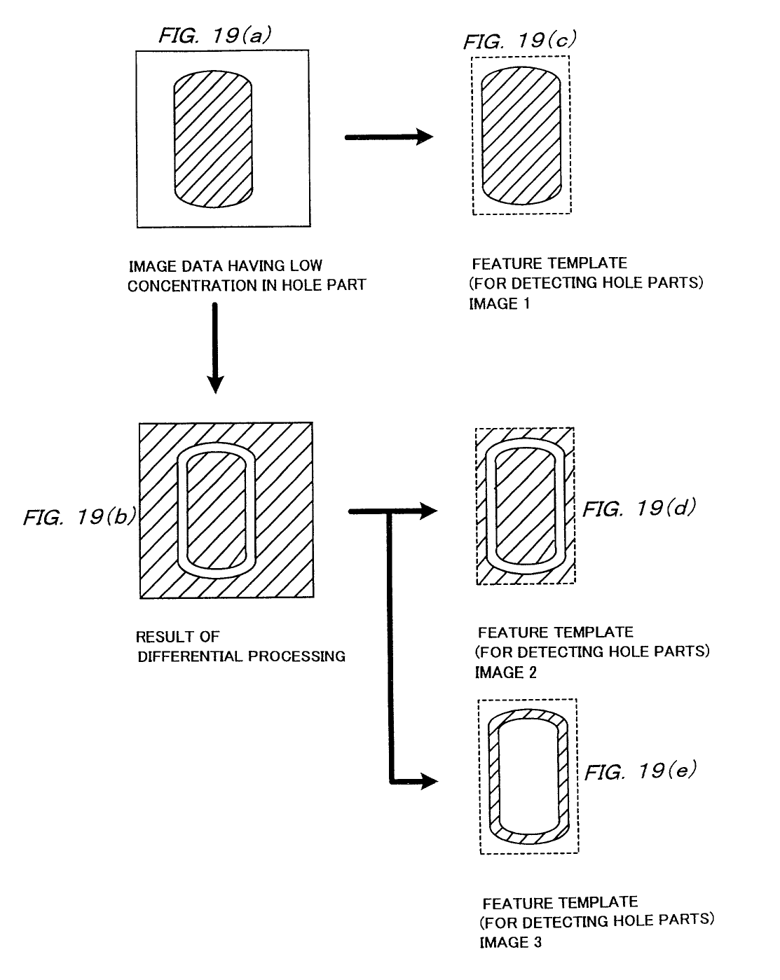

The first other embodiment (hereinafter referred to as “first modified example”) of the image processors 16a through 16d will be described by referring to FIGS. 18(a) through 18(f) as well as FIGS. 19(a) through 19(e).

FIG. 18(a) shows video signals (image data: original picture image) photographed by, for example, a CCD camera 200a wherein a target container 102 to be loaded and unloaded resides in the lower left part of the image data of the drawing.

FIG. 18(b) shows a result (a part represented by oblique lines) obtained by detecting the upper surface 102a region of the container load cargo 102. A manner for detecting the upper surface 102a region of the container load cargo 102 can be realized by combining binarizing processing wherein a region having a certain value equal to or higher than a threshold value is detected with differential processing by which a contour line of the container load cargo 102 can be extracted.

Furthermore, FIG. 18(c) is a view wherein a linear approximation is made upon a contour line of the container 102 in the upper surface 102a region of the container load cargo 102 detected by the manner as shown in FIG. 18(b) to detect an intersecting point. As a manner for approximating linearly a contour line of the container 102 in the upper surface 102a region of the target container load cargo 102 detected, for example, Hough transform (reference: e.g., “Handbook of Image Analysis” under the editorship of Mikio Takagi, and Haruhisa Shimoda; Publishing Institute of Tokyo University, p. 572) maybe utilized.

FIG. 18(d) shows a result (a part represented by slanted lines) obtained by setting up a region wherein the corner fitting 104a may be considered to reside on the basis of the intersecting point detected in FIG. 18(c) as a reference. For instance, an approximate size wherein four corner fittings 104a are contained is set up on the basis of the intersecting point detected in FIG. 18(c).

FIGS. 19(c), 19(d), and 19(e) show three types of feature template (for detecting hole parts) images for detecting a central position in a hole part of the corner fitting 104a in accordance with template matching processing (a feature template (for detecting hole parts) image 1 in FIG. 19(c), a feature template (for detecting hole parts) image 2 in FIG. 19(d), and a feature template (for detecting hole parts) image 3 in FIG. 19(e)), respectively.

In this case, FIG. 19(a) shows image data of a corner fitting in the case where a concentration of a hole part is low. FIG. 19(b) shows a result obtained by subjecting FIG. 19(a) to differential processing. FIG. 19(c) is a view wherein a region of the hole part in FIG. 19(a) is extracted to obtain the feature template (for detecting hole parts) image 1. FIG. 19(d) is a view wherein a region of the hole part in FIG. 19(b) is extracted to obtain the feature template (for detecting hole parts) image 2. FIG. 19(e) is a view wherein a concentration in FIG. 19(d) is reversed to obtain a feature template (for detecting hole parts) image 3.

The feature template (for detecting hole parts) image 1 is the one for detecting a central position in a hole part of a corner fitting from image data of a corner fitting in accordance with template matching processing in the case where a concentration in a hole part is low as in FIG. 19(a).

The feature template (for detecting hole parts) image 3 is the one for detecting a central position in a hole part of a corner fitting from image data of a corner fitting in accordance with template matching processing in the case where a concentration in a hole part is higher than that of the peripheral part thereof unlike in FIG. 19(a).

The feature template (for detecting hole parts) image 2 is the one for detecting a central position in a hole part of a corner fitting from image data of a corner fitting in accordance with template matching processing as to an image having a concentration distribution, which cannot been detected by the feature template (for detecting hole parts) image 1 and the feature template (for detecting hole parts) image 3 by utilizing a configuration of the hole part of the corner fitting and the concentration distribution.

In FIG. 18 (e), template matching processing is carried out in the detecting region shown in FIG. 18(d) by the use of three types of feature template (for detecting hole parts) images of the feature template (for detecting hole parts) image 1 shown in FIG. 19(c), the feature template (for detecting hole parts) image2 shown in FIG. 19(d) , and the feature template (for detecting hole parts) image 3 shown in FIG. 19(e) to detect a central position in a hole part of a corner fitting.

An example of a method for evaluating correlation values of three types of feature template (for detecting hole parts) images among the feature template (for detecting hole parts) image 1, the feature template (for detecting hole parts) image 2, and the feature template (for detecting hole parts) image 3 will be described hereinafter.

<Priority Sequence 1>

When a correlation value of the feature template (for detecting hole parts) image 1 is equal to or more than 0.75, a hole central position detected by the feature template (for detecting hole parts) image 1 is adopted.

<Priority Sequence 2>

When a correlation value of the feature template (for detecting hole parts) image 1 is less than 0.75 and a correlation value of the feature template (for detecting hole parts) image 3 is equal to or more than 0.40, a hole central position detected by the feature template (for detecting hole parts) image 3 is adopted.

<Priority Sequence 3>

When a correlation value of the feature template (for detecting hole parts) image 1 is less than 0.75, a correlation value of the feature template (for detecting hole parts) image 3 is less than 0.40, and a correlation value of the feature template (for detecting hole parts) image 2 is equal to or more than 0.25, a hole central position detected by the feature template (for detecting hole parts) image 2 is adopted.

<Priority Sequence 4>

Other cases than that mentioned above, it is judged that a hole central position cannot be detected.

Then, FIG. 18(f) shows a result of preparation of a template image of a corner fitting prepared on the basis of a hole central position of a corner fitting detected in FIG. 18(e).

In accordance with a manner with the use of image processors 16a through 16d in a detecting system for a container's location mentioned in the above-described respective embodiments (the first to the sixth embodiments) according to the present invention, it was processed in such that a region was set up on the basis of an intersecting point defined by two straight lines to use the resulting data as a template image for corner fittings 104a through 104d (see FIG. 7 and the explanation therefor). Because of such processing as described above, there is such a fear that when detection for the two straight lines was missed, an erroneous position became an intersecting point, so that an erroneous region had been set up as a template image for the corner fittings 104a through 104d.

On the other hand, in the above-described first modified example, it has been arranged in such that a region within which the corner fittings 104a through 104d are considered to reside on the basis of an intersecting point of the two straight lines is set up somewhat wider; and template matching processing is implemented based on three types of feature template (for detecting hole parts) images within the region to detect hole central positions, whereby template images of the corner fittings 104a through 104d are prepared. As a result, it becomes possible to prepare template images from regions of the corner fittings 104a through 104d.

(7-2) A second other embodiment for image processors 16a through 16d

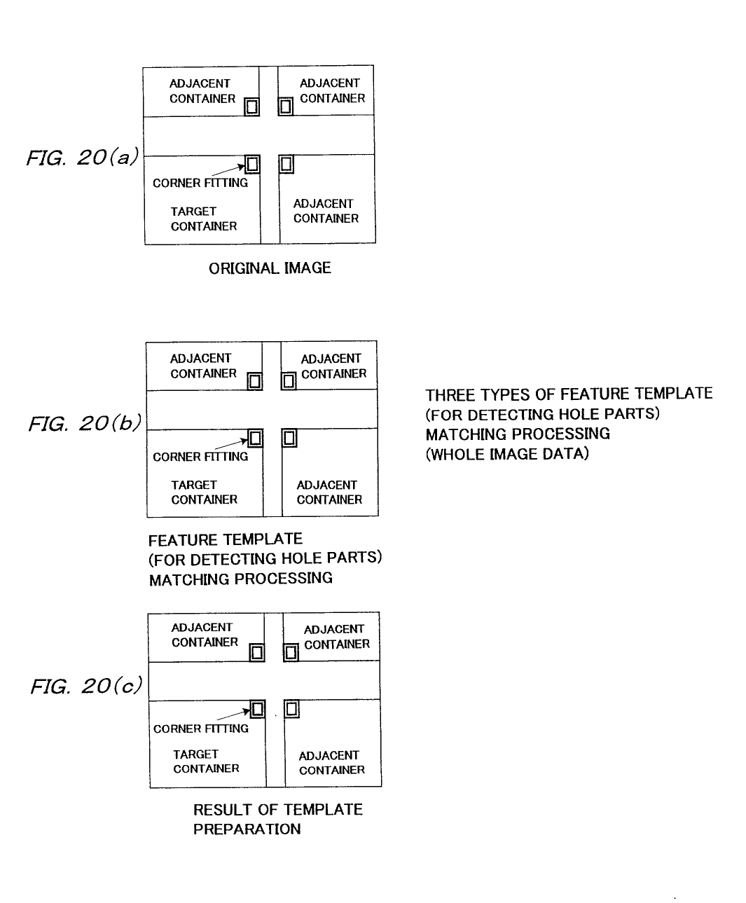

The second other embodiment (hereinafter referred to as “second modified example”) of the image processors 16a through 16d will be described by referring to FIGS. 20(a) though 20(c) wherein FIG. 20(a) shows video signals (image data: original picture image) photographed by, for example, a CCD camera 200a. In FIG. 20(a), it is assumed that a target container load cargo 102 resides in the lower left part in the image data of the drawing.

Then, in FIG. 20(b), template matching processing is performed in either the entire region or a designated region of the image data by the use of the three types of feature template (for detecting hole parts) images (the feature template (for detecting hole parts) image 1, the feature template (for detecting hole parts) image 2, and the feature template (for detecting hole parts) image 3) shown in FIGS. 19(c), 19(d), and 19(e), respectively, to detect a central position of a hole part of a corner fitting 104a. As a manner for designating a region, there is the one wherein regions in which coroner fittings exist in two adjacent containers on the upper side of image data in the drawing shown in FIG. 20 (b) may have been previously cancelled from, for example, a relative positional relation between a CCD camera 200a mounted on a hoisting accessory 100 and a target container load cargo 102. Hence, either the maximum four of corner fittings in case of the entire region, or the maximum two of corner fittings in case of are stricted region are detected. Itiseasily realized to select a corner fitting of the target container load cargo from these plural corner fittings, when a disposed situation of the container load cargo has been already known.

FIG. 20(c) shows a result of preparation of a template image of a corner fitting prepared on the basis of ahole central position of the corner fitting detected in FIG. 20(b).

In accordance with a manner with the use of image processors 16a through 16d in a detecting system for a container's location mentioned in the above-described respective embodiments (the first to the sixth embodiments) according to the present invention, it was processed in such that a region was set up on the basis of an intersecting point defined by two straight lines to use the resulting data as a template image for corner fittings 104a through 104d (see FIG. 7 and the explanation therefor). Because of the processing as described above, there is such a fear that when detection for the two straight lines was missed, an erroneous position became an intersecting point, so that an erroneous region had been set up as a template image for the corner fittings 104a through 104d.

On the other hand, in the above-described second modified example, it has been arranged in such that template matching processing is implemented on the basis of three types of feature template (for detecting hole parts) images in either the entire region or a previously restricted region of image data to detect a hole central position, so that template images of the corner fittings are prepared. As a result, it becomes possible that template images are obtained positively from regions of such corner fittings without requiring any detection of a contour line of a container.

(7-3) A third other embodiment for image processors 16a through 16d

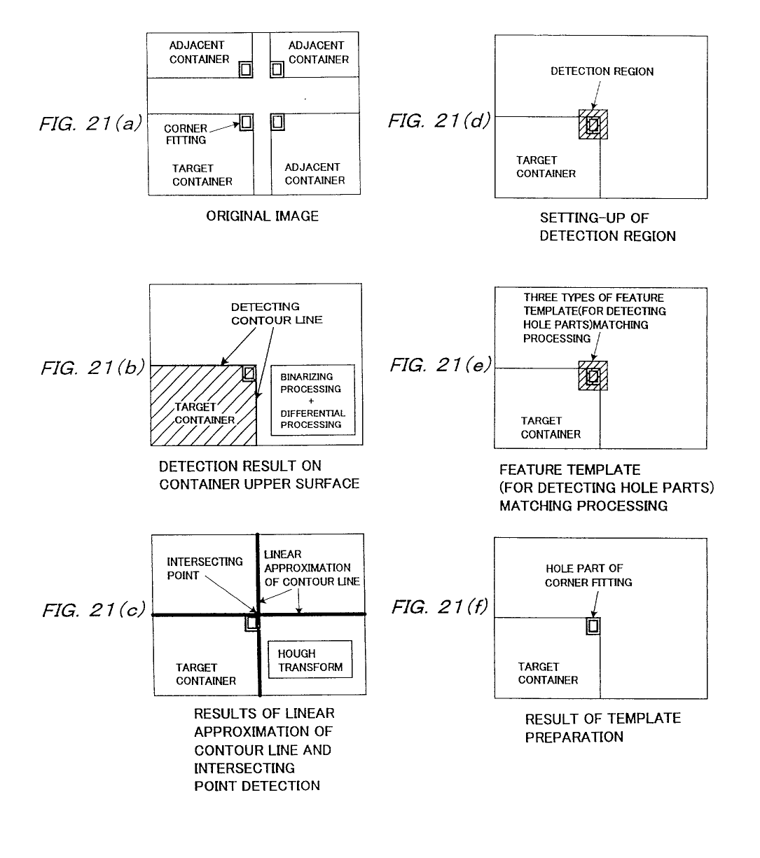

The third other embodiment (hereinafter referred to as “third modified example”) of the image processors 16a through 16d will be described by referring to FIGS. 21(a) through 21(f).

FIG. 21 (a) showsvideo signals (image data: original picture image) photographed by, for example, a CCD camera 200a wherein a target container 102 to be loaded and unloaded resides in the lower left part of the image data in the drawing.

FIG. 21(b) shows a result (a part represented by oblique lines) obtained by detecting the upper surface 102a region of the container load cargo 102. A manner for detecting the upper surface 102a region of the container load cargo 102 can be realized by combining binarizing processing wherein a region having a certain value equal to or higher than a threshold value is detected with differential processing by which a contour line of the container load cargo 102 can be extracted.

Furthermore, FIG. 21(c) is a view wherein a linear approximation is made upon a contour line of the container 102 in the upper surface 102a region of the container load cargo 102 detected by the manner as shown in FIG. 21(b) to detect an intersecting point thereof. As a manner for approximating linearly a contour line of the container 102 in the upper surface 102a region of the target container load cargo 102 detected, for example, Hough transform (reference: e.g., “Handbook of Image Analysis” under the editorship of Mikio Takagi, and Haruhisa Shimoda; Publishing Institute of Tokyo University, p. 572) may be utilized.

FIG. 21(d) shows a result (a part represented by slanted lines) obtained by setting up a region wherein the corner fitting 104a may be considered to reside on the basis of the intersecting point detected in FIG. 21(c) as a reference. For instance, an approximate size wherein four corner fittings are contained is set up on the basis of the intersecting point detected in FIG. 21(c).

In FIG. 21(e), template matching processing is implemented in the detected region shown in FIG. 21(d) by the use of three types of feature template (for detecting hole parts) images (a feature template (for detecting hole parts) image 1, a feature template (for detecting hole parts) image 2, and a feature template (for detecting hole parts) image 3) shown in FIGS. 19(c), 19(d), and 19(e) to detect a central position in a hole part of the corner fitting 104a.

FIG. 21(f) shows a result of preparation of a template image of a hole part of a corner fitting 104a prepared on the basis of a hole central position of the corner fitting 104 detected in FIG. 21(e).

In accordance with a manner with the use of image processors 16a through 16d in a detecting system for a container's location mentioned in the above-described respective embodiments (the first to the sixth embodiments) according to the present invention, it was processed in such that a region was set up on the basis of an intersecting point defined by two straight lines to use the resulting data as a template image for corner fittings 104a through 104d (see FIG. 7 and the explanation therefor). Because of the processing as described above, there is such a fear that when detection for the two straight lines was missed, an erroneous position became an intersecting point, so that an erroneous region had been set up as a template image for the corner fittings 104a through 104d.

On the other hand, in the above-described third modified example, it has been arranged in such that a region within which corner fittings are considered to reside on the basis of an intersecting point of the two straight lines is set up somewhat wider; and template matching processing is implemented based on three types of feature template (for detecting hole parts) images within the region to detect hole central positions, whereby template images of a hole part of the corner fittings are prepared. As a result, it becomes possible to prepare template images from regions of the corner fittings.

Moreover, since a template image is prepared from a region in a hole part of a corner fitting in the third modified example, the picture element number of the template image is smaller than that in a case where a template image is prepared from the entire region of a corner fitting. Thus, a processing time for template matching can be reduced.

(7-4) A fourth other embodiment for image processors 16a through 16d

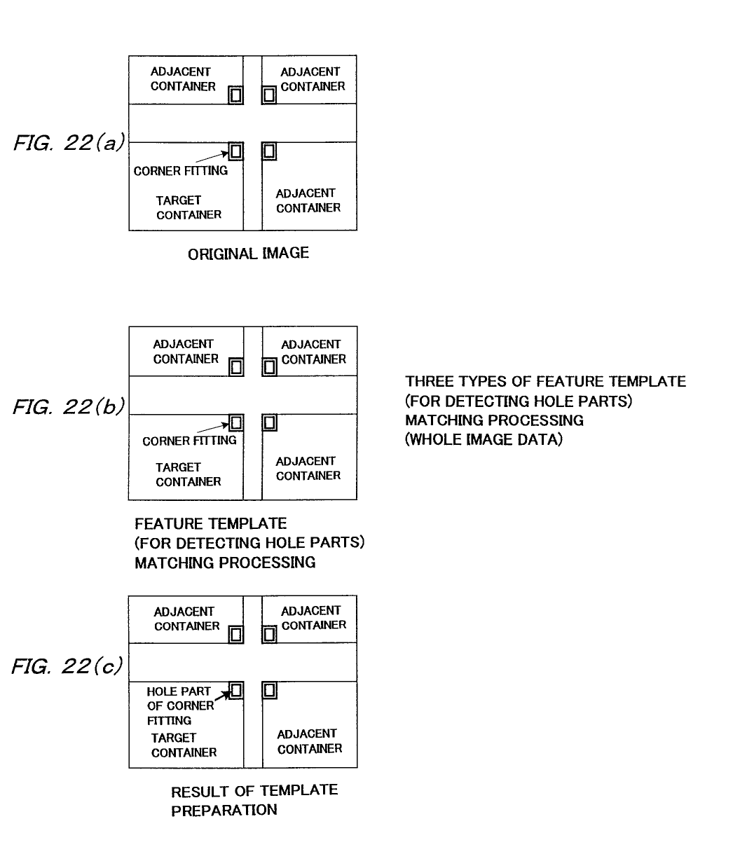

The fourth other embodiment (hereinafter referred to as “fourth modified example”) of the image processors 16a through 16d will be described by referring to FIGS. 22(a) though 22(c) wherein FIG. 22(a) shows video signals (image data: original picture image) photographed by, for example, a CCD camera 200a. In FIG. 22 (a), it is assumed that a target container load cargo 102 resides in the lower left part of the image data in the drawing.

In FIG. 22(b), template matching processing is performed in either the entire region or a designated region of the image data by the use of the three types of feature template (for detecting hole parts) images (the feature template (for detecting hole parts) image 1, the feature template (for detecting hole parts) image 2, and the feature template (for detecting hole parts) image 3) shown in FIGS. 19(c), 19(d), and 19(e), respectively, to detect a central position of a hole part of a corner fitting 104a. As a manner for designating a region, there is the one wherein regions in which coroner fittings exist in two adjacent containers on the upper side of image data in the drawing shown in FIG. 22(b) may have been previously cancelled from, for example, a relative positional relation between a CCD camera 200a mounted on a hoisting accessory 100 and a target container load cargo 102. Hence, either the maximum four of corner fittings in case of the entire region, or the maximum two of corner fittings in case of a restricted region are detected. It is easily realized to select a corner fitting 104a of the target container load cargo 102 from these plural corner fittings, when a disposed situation of the container load cargo has been already known.

FIG. 22(c) shows a result of preparation of a template image of a hole part in a corner fitting prepared on the basis of a hole central position of the corner fitting detected in FIG. 22(b).

In accordance with a manner with the use of image processors 16a through 16d in a detecting system for a container's location mentioned in the above-described respective embodiments (the first to the sixth embodiments) according to the present invention, it was processed in such that a region was set up on the basis of an intersecting point defined by two straight lines to use the resulting data as a template image for corner fittings 104a through 104d (see FIG. 7 and the explanation therefor). Because of such processing as described above, there is such a fear that when detection for the two straight lines was missed, an erroneous position became an intersecting point, so that an erroneous region had been set up as template images for the corner fittings 104a through 104d.

On the other hand, in the above-described fourth modified example, it has been arranged in such that template matching processing is implemented on the basis of three types of feature template (for detecting hole parts) images in either the entire region or a previously restricted region of image data to detect a hole central position, and template images in a hole part of the corner fittings are prepared on the basis of the hole central position detected. As a result, it becomes possible that template images are obtained positively from regions of hole parts of such corner fittings without requiring any detection of a contour line of a container.

Moreover, since a template image is prepared from a region in a hole part of a corner fitting in the fourth modified example, the picture element number of the template image is smaller than that in a case where a template image is prepared from the entire region of a corner fitting. Thus, a processing time for template matching can be reduced.

(7-5) As described above, the first through the fourth modified examples differ from a manner for preparing template images of corner fitting regions on the basis of an intersecting point of two straight lines obtained by approximating linearly a contour line of a container. Namely, in the first through the fourth modified examples, pluralities (three types) of template images in a hole part of a corner fitting have been previously prepared; a hole central position is detected in accordance with template matching processing, and then, template images are prepared from regions of either hole parts of corner fittings or corner fittings. Thus, it becomes possible that template images of the corner fittings or the hole parts of the corner fittings can be prepared with high reliably.

Therefore, reliability of a capability for detecting a container's location can be more improved in a detecting system for a container's location according to the present invention.

Since the present invention has been constituted as described above, such an excellent advantage that a three-dimensional relative position on the upper surface of a container load cargo can be correctly detected with respect to a hoisting accessory, even if a photographing distance between each of CCD cameras mounted on the hoisting accessory and the container load cargo changes with lowering of the hoisting accessory to vary a size of a corner fitting on video signals (image data) photographed by the CCD cameras.

Furthermore, since the present invention has been constituted as described above, such an excellent advantage that it becomes possible to perform correct template matching processing without preparing previously a number of template images (reference patterns) of corner fittings having various sizes, even if a photographing distance between each of CCD cameras mounted on the hoisting accessory and the container load cargo changes with lowering of the hoisting accessory to vary a size of a corner fitting on video signals (image data) photographed by the CCD cameras.

It will be appreciated by those of ordinary skill in the art that the present invention can be embodied in other specific forms without departing from the spirit or essential characteristics thereof.

The presently disclosed embodiments are therefore considered in all respects to be illustrative and not restrictive. The scope of the invention is indicated by the appended claims rather than the foregoing description, and all changes that come within the meaning and range of equivalents thereof are intended to be embraced therein.

The entire disclosures of Japanese Patent Application No. 2000-223683 filed on Jul. 25, 2000 and Japanese Patent Application No. 2001-91911 filed on Mar. 28, 2001 including specifications, claims, drawings and summaries are incorporated herein by reference in their entirety.

What is claimed is:

1. A detecting system for a container's location comprising:
a plurality of CCD cameras disposed vertically downward on a hoisting accessory, which is mounted on a crane for conveying containers, and photographing a plurality of corner fittings mounted on the upper surface of a container to be loaded and unloaded (container load cargo), respectively;
a distance finder for determining a distance between said hoisting accessory and said container load cargo;
an image processor for image-processing video signals from said CCD cameras to detect two-dimensional coordinates of said corner fittings on the upper surface of said container load cargo; and
an arithmetic and control unit for performing an arithmetical operation of a three-dimensional relative position on the surface of said container load cargo with respect to said hoisting accessory on the basis of the two-dimensional coordinates of said plurality of corner fittings on the upper surface of said container load cargo, which were detected by said image processor, as well as distance information indicating a distance between said hoisting accessory and said container load cargo, which was determined by said distance finder;
whereby a three-dimensional relative position defined between said hoisting accessory and said container load cargo is detected.

2. A detecting system for a container's location comprising:
a plurality of CCD cameras disposed vertically downward on a hoisting accessory, which is mounted on a crane for conveying containers, and photographing a plurality of corner fittings mounted on the upper surface of a container load cargo, respectively;
a plurality of illuminating light sources disposed vertically downward on said hoisting accessory and for illuminating said plurality of corner fittings mounted on the upper surface of said container load cargo, respectively;
a distance finder for determining a distance between said hoisting accessory and said container load cargo;
an image processor for image-processing video signals from said CCD cameras to detect two-dimensional coordinates of said corner fittings on the upper surface of said container load cargo; and
an arithmetic and control unit for performing an arithmetical operation of a three-dimensional relative position on the surface of said container load cargo with respect to said hoisting accessory on the basis of the two-dimensional coordinates of said plurality of corner fittings on the upper surface of said container load cargo, which were detected by said image processor, as well as distance information indicating a distance between said hoisting accessory and said container load cargo, which was determined by said distance finder;
whereby a three-dimensional relative position defined between said hoisting accessory and said container load cargo is detected.

3. A detecting system for a container's location as claimed in claim 2, comprising further a controller for adjusting outputs of said plurality of illuminating light sources based on the distance information indicating a distance between said hoisting accessory and said container load cargo determined by said distance finder.

4. A detecting system for a container's location as claimed in claim 1 wherein:
said image processor is the one for detecting said corner fittings on the upper surface of said container load cargo in accordance with template matching processing or the like processing, which image-processes video signals from said CCD cameras to detect a region wherein said corner fittings are located, and prepares template images on the basis of said results detected.

5. A detecting system for a container's location as claimed in claim 2 wherein:
said image processor is the one for detecting said corner fittings on the upper surface of said container load cargo in accordance with template matching processing or the like processing, which image-processes video signals from said CCD cameras to detect a region wherein said corner fittings are located, and prepares template images on the basis of said results detected.

6. A detecting system for a container's location as claimed in claim 3 wherein:
said image processor is the one for detecting said corner fittings on the upper surface of said container load cargo in accordance with template matching processing or the like processing, which image-processes video signals from said CCD cameras to detect a region wherein said corner fittings are located, and prepares template images on the basis of said results detected.

7. A detecting system for a container's location as claimed in claim 4 wherein:
said image processor is the one for updating sizes of said template image on the basis of distance information indicating a distance between said hoisting accessory and said container load cargo determined by said distance finder to detect said corner fittings on the upper surface of said container load cargo by the use of the template images thus updated and input images represented by the video signals from said CCD cameras in accordance with template matching processing.

8. A detecting system for a container's location as claimed in claim 5 wherein:
said image processor is the one for updating sizes of said template image on the basis of distance information indicating a distance between said hoisting accessory and said container load cargo determined by said distance finder to detect said corner fittings on the upper surface of said container load cargo by the use of the template images thus updated and input images represented by the video signals from said CCD cameras in accordance with template matching processing.

9. A detecting system for a container's location as claimed in claim 6 wherein:
said image processor is the one for updating sizes of said template image on the basis of distance information indicating a distance between said hoisting accessory and said container load cargo determined by said distance finder to detect said corner fittings on the upper surface of said container load cargo by the use of the template images thus updated and input images represented by the video signals from said CCD cameras in accordance with template matching processing.

10. A detecting system for acontainer's location as claimed in claim 4 wherein:
said image processor is the one for changing sizes of input images represented by the video signals from said CCD cameras on the basis of distance information indicating a distance between said hoisting accessory and said container load cargo determined by said distance finder to detect said corner fittings on the upper surface of said container load cargo by the use of the input images the sizes of which were thus changed and said template images thus updated in accordance with template matching processing.

11. A detecting system for a container's location as claimed in claim 5 wherein:
said image processor is the one for changing sizes of input images represented by the video signals from said CCD cameras on the basis of distance information indicating a distance between said hoisting accessory and said container load cargo determined by said distance finder to detect said corner fittings on the upper surface of said container load cargo by the use of the input images the sizes of which were thus changed and said template images thus updated in accordance with template matching processing.

12. A detecting system for a container's location as claimed in claim 6 wherein:
said image processor is the one for changing sizes of input images represented by the video signals from said CCD cameras on the basis of distance information indicating a distance between said hoisting accessory and said container load cargo determined by said distance finder to detect said corner fittings on the upper surface of said container load cargo by the use of the input images the sizes of which were thus changed and said template images thus updated in accordance with template matching processing.

13. A detecting system for a container's location as claimed in claim 1 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

14. A detecting system for a container's location as claimed in claim 2 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

15. A detecting system for a container's location as claimed in claim 3 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

16. A detecting system for a container's location as claimed in claim 4 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

17. A detecting system for a container's location as claimed in claim 5 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

18. A detecting system for a container's location as claimed in claim 6 wherein:
said plurality of CCD cameras are the ones each for changing automatically a photographing magnification on the basis of distance information indicating a distance between said hoisting accessory and said container load cargo determined by said distance finder to keep a size of an input image represented by video signals from said CCD cameras always constant.

19. A detecting system for a container's location as claimed in claim 1 wherein:
said image processor is the one for detecting said corner fittings on the upper surface of said container load cargo in accordance with template matching processing or the like processing, which stores a region wherein said corner fittings each having a size in response to distance information indicating a distance between said hoisting accessory and said container load cargo have been located as a template image.

20. A detecting system for a container's location as claimed in claim 2 wherein:
said image processor is the one for detecting said corner fittings on the upper surface of said container load cargo in accordance with template matching processing or the like processing, which stores a region wherein said corner fittings each having a size in response to distance information indicating a distance between said hoisting accessory and said container load cargo have been located as a template image.

21. A detecting system for a container's location as claimed in claim 3 wherein:
said image processor is the one for detecting said corner fittings on the upper surface of said container load cargo in accordance with template matching processing or the like processing, which stores a region wherein said corner fittings each having a size in response to distance information indicating a distance between said hoisting accessory and said container load cargo have been located as a template image.

22. A detecting system for a container's location as claimed in claim 1 wherein:
said image processor is the one for detecting said corner fittings on the upper surface of said container load cargo in accordance with template matching processing, which involves a preparation means for preparing template images of corner fittings in said every container load cargos; and
said preparation means is the one for image-processing video signals from said CCD cameras to restrict a region wherein said corner fittings reside in case of implementing said template matching processing, executing template matching processing by the use of template images for detecting hole parts of a plurality of corner fittings, which have been previously prepared in the restricted region to detect hole central positions in the corner fittings, and preparing template images of the corner fittings on the basis of the hole central positions of said corner fittings thus detected.

23. A detecting system for a container's location as claimed in claim 2 wherein:
said image processor is the one for detecting said corner fittings on the upper surface of said container load cargo in accordance with template matching processing, which involves a preparation means for preparing template images of corner fittings in said every container load cargos; and
said preparation means is the one for image-processing video signals from said CCD cameras to restrict a region wherein said corner fittings reside in case of implementing said template matching processing, executing template matching processing by the use of template images for detecting hole parts of a plurality of corner fittings, which have been previously prepared in the restricted region to detect hole central positions in the corner fittings, and preparing template images of the corner fittings on the basis of the hole central positions of said corner fittings thus detected.

24. A detecting system for a container's location as claimed in claim 3 wherein:
said image processor is the one for detecting said corner fittings on the upper surface of said container load cargo in accordance with template matching processing, which involves a preparation means for preparing template images of corner fittings in said every container load cargos; and
said preparation means is the one for image-processing video signals from said CCD cameras to restrict a region wherein said corner fittings reside in case of implementing said template matching processing, executing template matching processing by the use of template images for detecting hole parts of a plurality of corner fittings, which have been previously prepared in the restricted region to detect hole central positions in the corner fittings, and preparing template images of the corner fittings on the basis of the hole central positions of said corner fittings thus detected.

25. A detecting system for a container's location as claimed in claim 1 wherein:
said image processor is the one for detecting said corner fittings on the upper surface of said container load cargo in accordance with template matching processing, which involves a preparation means for preparing template images of corner fittings in said every container load cargos; and
said preparation means is the one for executing template matching processing by the use of template images for detecting hole parts of a plurality of corner fittings, which have been previously prepared with respect to video signals from said CCD cameras to detect hole central positions in the corner fittings in case of implementing said template matching processing, and preparing template images of the corner fittings on the basis of the hole central positions of said corner fittings thus detected.

26. A detecting system for a container's location as claimed in claim 2 wherein:
said image processor is the one for detecting said corner fittings on the upper surface of said container load cargo in accordance with template matching processing, which involves a preparation means for preparing template images of corner fittings in said every container load cargos; and
said preparation means is the one for executing template matching processing by the use of template images for detecting hole parts of a plurality of corner fittings, which have been previously prepared with respect to video signals from said CCD cameras to detect hole central positions in the corner fittings in case of implementing said template matching processing, and preparing template images of the corner fittings on the basis of the hole central positions of said corner fittings thus detected.

27. A detecting system for a container's location as claimed in claim 3 wherein:
said image processor is the one for detecting said corner fittings on the upper surface of said container load cargo in accordance with template matching processing, which involves a preparation means for preparing template images of corner fittings in said every container load cargos; and
said preparation means is the one for executing template matching processing by the use of template images for detecting hole parts of a plurality of corner fittings, which have been previously prepared with respect to video signals from said CCD cameras to detect hole central positions in the corner fittings in case of implementing said template matching processing, and preparing template images of the corner fittings on the basis of the hole central positions of said corner fittings thus detected.

28. A detecting system for a container's location as claimed in claim 1 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for image-processing video signals from said CCD cameras to restrict a region wherein said corner fittings reside in case of implementing said template matching processing, and executing template matching processing by the use of template images for detecting vicinities of holes of a plurality of corner fittings, which have been previously prepared in the restricted region, to prepare template images of the vicinities of the holes of the corner fittings.

29. A detecting system for a container's location as claimed in claim 2 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for image-processing video signals from said CCD cameras to restrict a region wherein said corner fittings reside in case of implementing said template matching processing, and executing template matching processing by the use of template images for detecting vicinities of holes of a plurality of corner fittings, which have been previously prepared in the restricted region, to prepare template images of the vicinities of the holes of the corner fittings.

30. A detecting system for a container's location as claimed in claim 3 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for image-processing video signals from said CCD cameras to restrict a region wherein said corner fittings reside in case of implementing said template matching processing, and executing template matching processing by the use of template images for detecting vicinities of holes of a plurality of corner fittings, which have been previously prepared in the restricted region, to prepare template images of the vicinities of the holes of the corner fittings.

31. A detecting system for a container's location as claimed in claim 1 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for executing template matching processing by the use of template images for detecting vicinities of holes of a plurality of corner fittings, which have been previously prepared with respect to video signals from said CCD cameras to prepare template images of the vicinities of the holes of the corner fittings in case of implementing said template matching processing.

32. A detecting system for a container's location as claimed in claim 2 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for executing template matching processing by the use of template images for detecting vicinities of holes of a plurality of corner fittings, which have been previously prepared with respect to video signals from said CCD cameras to prepare template images of the vicinities of the holes of the corner fittings in case of implementing said template matching processing.

33. A detecting system for a container's location as claimed in claim 3 wherein:
said image processor is the one for detecting said corner fittings on the upper surface of said container load cargo in accordance with template matching processing, which involves a preparation means for preparing template images of vicinities of holes of corner fittings in said every container load cargos; and
said preparation means is the one for executing template matching processing by the use of template images for detecting vicinities of holes of a plurality of corner fittings, which have been previously prepared with respect to video signals from said CCD cameras to prepare template images of the vicinities of the holes of the corner fittings in case of implementing said template matching processing.
